(19) United States
(12) Patent Application Publication
(10) Pub. No.: US 2008/0305341 A1
(43) Pub. Date: Dec. 11, 2008

(54) Process for Coating Metallic Surfaces With an Anti-Corrosive Coating

(76) Inventors: Waldfried Plieth, Dresden (DE); Ursula Rammelt, Dresden (DE); Nils Hebestreit, Dresden (DE); Martin Stratmann, Meerbusch (DE); Michael Rohwerder, Dusseldorf (DE); Hans-Jurgen Adler, Pirna (DE); Karin Potje-Kamloth, Dresden (DE); Evelin Jahne, Ottendorf-Okrilla (DE); Andrij Pich, Dresden (DE); Heribert Domes, Weilmunster (DE); Julia Schneider, Marburg (DE); Grazyna Paliwoda-Probeska, Duisburg (DE)

Correspondence Address: James R Crawford;Fulbright & Jaworski, 666 Fifth Avenue, New York, NY, 10103, US

(21) Appl. No.: 11/659,165

(22) PCT Filed: Aug. 1, 2005
(86) PCT No.: PCT/EP05/08309

§ 371 Date: Sep. 19, 2007

(30) Foreign Application Priority Data
Aug. 3, 2004 (DE) 10 2004 037 542.9
Aug. 3, 2004 (DE) 10 2004 037 552.6
Jun. 30, 2005 (DE) 10 2005 030 488.5
Jun. 30, 2005 (DE) 10 2005 030 489.3

(51) Int. Cl. B32B 15/08; H01B 1/00; B05D 5/12

(52) U.S. Cl. 428/419; 427/77; 252/500; 252/519.34; 427/78; 428/425.8

(57) ABSTRACT

A process is disclosed for coating metallic surfaces with an anti-corrosive composition that contains a conductive polymer and is a dispersion that contains the at least one conductive polymer mainly or entirely in particulate form, as well as a binder system. The conductive polymer is at least one polymer based on polyphenylene, polyfuran, polyimidazole, polyphenanthrene, polypyrrole, polythiophene and/or polythiophenylene charged with anti-corrosive mobile anions. Alternatively, the metallic surfaces can be first coated with a dispersion based on conductive polymers in particulate form, then coated with a composition which contains a binder system.

The present invention relates to a process for coating metallic surfaces with particles that contain conductive polymer, especially in their shell layer, the composition for the aforesaid coating, the substrates coated with an electrically conductive coating, as well as the use of the substrates coated in this way.

Many substances of the class of electrically conductive polymers, in particular based on polyaniline, have been known for some years. Many chemical systems with electrically conductive polymers have been developed that can be used without additions of other electrically conductive substances. In this connection it has been found that various constituents have to be added and specific process steps have to be carried out in order to achieve a relatively good electrical conductivity. In many applications a solid layer or thin closed layer of conductive polymers, such as for example in the corrosion protection of metallic surfaces, has not proved effective.

The introduction of conductive polymers into an organic matrix is however difficult to accomplish without introducing particles which, during the mixing or wetting by shear forces (often so-called grinding), intensify the intermixing and distribution of the conductive polymers in a matrix. The fact is, powders of conductive polymers produced without a core and that exhibit roughly the same properties as the coatings of a pure conductive polymer are more difficult to incorporate and exhibit a poorer degree of mixing among the constituents of the composition of the organic coating. Moreover, since these powders often consist of fibrous adhesive structures, they can easily coalesce.

Many types of inorganic and organic particles, in particular pigments, are in principle known, which are used in the coated state, for example coated with an oxidic covering, such as for example various types of pigments.

The application of a mixture containing monomers and/or oligomers which can react to form a conductive polymer can cause problems on and/or in particle cores, since many organic core materials can be dissolved or broken down by the solvents, since inorganic particles cannot be as flexibly adjusted as organic particles to the properties of the coatings, such as for example to the glass transition temperature Tg and to the concentration in the mixture, and also cannot be chemically optimised as regards the surface properties, for example by crosslinking and/or grafting. In addition the particle size distribution in the case of inorganic particles cannot be varied so widely as in organic particles, especially as regards the narrow width of the distribution, but also as regards the particle shape. Furthermore organic particles are often chemically better matched to organic binders, which are sometimes necessary for the organic binder matrix. Apart from this inorganic particles are usually commercially obtainable in platelet, linear or needle form.

In this connection core materials often have to be selected that are as far as possible completely insoluble in the chosen solvents or liquids, as are in most cases those materials based in particular on polyacrylate, polycarbonate, polyethylene, polyimide, polystyrene and/or polyurethane, and as are all inorganic particles. In principle other organic polymeric particles may also be used. Accordingly the choice on the one hand of the core materials and on the other hand of the usable solvents is restricted when coating organic particles. Since the hardness of the organic cores and their shell is low, it should be ensured that the coated particles are not destroyed when subjected to fairly severe shear forces (so-called grinding). The term grinding is used hereinafter, without making a distinction as to whether only a wetting effected by shear forces is involved, or in fact a grinding involving a comminution is involved.

The patent applications DE 102004037542, DE 102004037552 and the foreign applications derived therefrom as well as the parallel application filed at the same Patent Office by the same applicant under the title “Process for coating fine particles with conductive polymers” and also their foreign applications, are expressly incorporated in the present application, in particular as regards the types and amounts of the depot substances, anions, cations, matrix substances, the starting, intermediate and end substances and the further components that are added or formed, and also in particular as regards the chemical reactions, the production processes and conditions, the individual process steps, the physicochemical phenomena, the conductivities, the potential values, the potential differences, the potential changes and other properties, the definitions, the subject-matters of the claims, the figures, the tables, as well as the uses, variants, embodiments, examples and comparison examples.

The applicants are not aware of any publication in which also only a small number of types of anions was varied in connection with conductive polymers. Since the production of a conductive polymer is not commercially feasible with many compounds and therefore the polymer in this case has to be prepared carefully ab initio, and it is very complicated to vary the production conditions, work on the systematic variation of educts for the conductive polymer, and of anions and oxidising agents is obviously not carried out, especially not in the case of polymers based on polypyrrole or polythiophene.

In most investigations carried out in the prior art on the production and use of conductive polymers, anions—as a rule termed counter-anions or doping anions—are on account of the production conditions inevitably contained in the mixtures in order to maintain the electrical neutrality of the conductive polymer during its formation. However, very little is known about the protective effect of such anions in the use of conductive polymers. The relevant literature seldom contains any information on an anti-corrosive action of the anions in the conductive polymer. However, in individual experiments a passivation of the metallic surface is carried out beforehand, in which for example a sparingly soluble metal oxalate passivation layer is formed simply from oxalate, before the chemical system with the conductive polymer is applied. When using for example a polyaniline, an undoped polyaniline is normally applied with this system and is doped only subsequently, for example with phosphoric acid. The prior passivation is however always necessary if the conductive polymer is applied electrochemically. The same anion which is used in the passivation is then necessarily present, and is simultaneously incorporated as a counter-ion in the polymerisation of the conductive polymer, in order to ensure electrical neutrality.

It has now been found that the anions to be added not only ensure the necessary electrical neutrality when they are incorporated into the structure of the conductive polymers, but can also exert an anti-corrosive action on a metallic surface if they migrate out from the conductive polymers. The anti-corrosive action occurs already in the case of minor damage to the coating, since these selected anions migrate from the conductive polymer and migrate to the site of damage in the protective layer on the metallic surface. The defective metallic surface may in many cases be passivated, especially if it is not too large.

It has also been found that a cathodic delamination generally occurs following corrosive attack on a metallic surface. In addition it has been found in this connection that this cathodic delamination is in many cases preceded by a drop in potential as a release signal. The release signal generally occurs in the damaged region, since there the potential in the case of the common industrial metals and their alloys is almost without exception more negative than the redox potential of the common conductive polymers. The latter are thereby negatively polarised and thus reduced.

In the cathodic delamination the actual interfacial delamination is preceded by a potential drop, in which the potential at the interface already falls in this preliminary stage of the delamination from a value at which the ordinary conductive polymers are present in the oxidised state, to a more negative value leading at least to some extent to a reduction. In this connection, at this forwardly displaced cathodic front, in which the polymer adhesion is not yet destroyed, an oxygen reduction often also occurs at the interface, in which radicals are formed that destroy the adhesion at the interface and thus finally lead to the delamination. Also, at least one bubble may be formed at a delaminated site.

It has now been found that these effects can be utilised firstly to prevent a further delamination, and/or secondly in this early stage to prevent delamination, by releasing anions that inhibit this reaction. If the interface in this early stage has not yet undergone delamination, then only small amounts of such anions are necessary on account of the small free volume of the still largely intact interface.

This chemical system is effective in the case of small defects, but cannot passivate large defects and may therefore even lead to a disaster if the cation transport rate in the overall system is too high and if this therefore leads to a rapidly occurring reaction, for example of the organic coating with a content of conductive polymers. In this case the important point is to match all the amounts and properties in this chemical system for the corrosion inhibition of metallic surfaces. However, chromate alone likewise cannot passivate defects that are too large.

In many chemical systems that contain conductive polymers, an effect based on the release of anions (release effect) is hoped for or assumed, but has been detected only in rare individual cases. The inclusions of the conductive polymers in a coating could therefore possibly serve as depots for passivating substances, for example passivating anions. The anions described in this connection in the literature are generally not corrosion inhibiting anions. The utilisation of a release effect for an anti-corrosive application is however mentioned only rarely and then often vaguely, and to the best knowledge of the applicants has never been detected in practice and therefore remains a hypothesis. The triggering of a release effect by a potential drop has however to the best knowledge of the applicants never been described before.

Where however anti-corrosive anions are described in the prior art, the anti-corrosive action is largely restricted to a passivating action on the local defective sites, and there is no description of the region specifically undergoing delamination. With conductive polymers a distinction has to be made as to whether the polymers are chemically or electrochemically polymerised, since in the case of electrochemical polymerisation the comparatively reactive metallic surface is always passivated before the deposition of the polymer: for example, when using oxalate salts the metallic surface is always passivated beforehand. The publications that describe the corrosion-inhibiting anions do not, to the best knowledge of the applicants, indicate any release of these anions as a result of a potential drop.

Apart from a self-healing effect, only the following is known about chromium VI-containing coatings that are free from conductive polymers: 1. Passivation of the metallic surface at the defect or even at the damaged site (anodic partial reaction). 2. Inhibition of the cathodic partial reaction (oxygen reduction) in the region specifically undergoing delamination and/or that is already delaminated. Nevertheless hexavalent chromate is known to be damaging, and for reasons of environmental protection the chromate content used to protect metallic surfaces is drastically reduced. Apart from this, chromate can passivate and heal only small defects and not large-scale defects. Up to now no chemical system is known that actually exhibits more than such a self-healing effect in the absence of hexavalent chromate.

The object of the present invention was accordingly to provide processes for coating metallic surfaces and particles with compositions that contain conductive polymer on and/or in particles, and which are suitable in principle for use in preventing corrosion of metallic surfaces. It would be advantageous if the preparation of this composition and the coating processes could be carried out as simply as possible and without special equipment and apparatus.

In addition it would be particularly advantageous if in fact individual members of the chemical systems with conductive polymers in coatings on metallic substrates could recognise a damage of the coating not only by a change of potential with a gradient of the electrical field (release of anions; release effect), but could also exhibit a healing effect (repair effect). The healing effect, in which a delaminated site is repaired, may however be hoped for only in the case of a few individual chemical systems.

This object is achieved by a process for coating metallic surfaces with an anti-corrosive composition that contains conductive polymers, in which the composition is a dispersion that contains at least one conductive polymer largely or wholly in particulate form as well as a binder system, in which the conductive polymer is at least one polymer based on polyphenylene, polyfuran, polyimidazole, polyphenanthrene, polypyrrole, polythiophene and/or polythiophenylene, which is charged with anti-corrosive mobile anions.

This object is also achieved by a process for coating metallic surfaces with an anti-corrosive composition that contains conductive polymer, in which first of all a first composition that is a dispersion that contains at least one conductive polymer largely or wholly in particulate form, is applied to the metallic surface and is also dried, and in which a second composition containing a binder system is then applied as a dispersion (=solution, emulsion and/or suspension) to the precoated metallic surface and is dried and optionally also polymerised, wherein the conductive polymer is at least one polymer based on polyphenylene, polyfuran, polyimidazole, polyphenanthrene, polypyrrole, polythiophene and/or polythiophenylene, which is charged with anti-corrosive mobile anions.

Where the term “composition” is used hereinafter, this may denote as necessary each of the compositions disclosed in claims 1 and 2.

If the conductive polymer is present not only in particulate form, it may for example also to some extent be present as a solution, sol, gel or precipitation product; at the same time or alternatively the polymer not present in particle form may also first of all be applied, or has already been applied, in the form of a thin or very thin coating, before at least one composition according to the invention is applied.

Such an, often very thin, coating need not however be sealed; it may in this connection form a first depot directly on or very close to the metallic surface, which on account of the short paths to the metallic surface acts particularly rapidly and effectively, while the coating applied thereto can form the main reserve of conductive polymer, in particular for stopping corrosion and for repairing not very small defects. Such a thin coating based on conductive polymer may for example be applied separately from the following composition according to the invention, containing a binder system. Such a coating can be applied to fast-moving strips, for example using a first rollcoater, or in many cases preferably by roller application or spraying, optionally followed by squeeze-drying.

In principle any type of dryer may be used to dry the first composition: a partial drying (=initial drying), in which often a certain adhesion of the resultant coating is to be achieved, a more or less vigorous or a more or less complete drying (=drying), or a drying in situ, which is drying of a coating on a specific surface, for example on a strip (=dry-in-place).

Particularly preferably each type of conductive polymer that is used is charged with anti-corrosive mobile anions.

The object is also achieved with a composition for coating a metallic surface, which is characterised in that the composition contains:
At least one water-soluble or water-dispersed organic polymer,
particles containing at least one type of conductive polymer,
water,
optionally at least one organic solvent, and
optionally at least one additive.

In this connection it is particularly preferred if this composition contains conductive polymer in which anions based on titanium and/or zirconium are incorporated, and/or if the composition contains at least one compound of titanium and/or zirconium.

The object is furthermore achieved with articles that are provided on a metallic surface with a coating based on binder system, particles and conductive polymer, which is prepared according to the invention.

This coating contains in particular conductive polymer that comprises anions containing titanium and/or zirconium, and or at least one compound of titanium and/or zirconium.

It has now been found that a process for coating inorganic and/or organic particles, in which the particles are present in a mixture and/or are initially formed therein, in which the mixture is a dispersion, a flowable or kneadable composition, a sol and/or a gel, is ideally suitable for the production of conductive polymer, in particular on inorganic and/or organic particles, in which the mixture, termed educt mixture contains:
at least one monomer and/or at least one oligomer—hereinafter termed “educt(s) of the conductive polymers” or only “educt(s)”
   selected from monomers and/or oligomers of aromatic compounds and/or unsaturated hydrocarbon compounds such as for example alkynes, heterocyclic compounds, carbocyclic compounds, their derivatives and/or their combinations, in particular selected from heterocyclic compounds where X=N and/or S, which are suitable for forming therefrom electrically conducting oligomer/polymer/copolymer/block copolymer/graft copolymer, in particular selected from unsubstituted and/or substituted compounds based on imidazole, naphthalene, phenanthrene, pyrrole, thiophene and/or thiophenol,
   wherein at least one educt for the production of at least one conductive polymer is selected so that its oxidation potential is less than or equal to the decomposition potential of water and/or of at least one other polar solvent in the mixture used therefor, and
   wherein the release of mobile anti-corrosive anions and optionally also of coupling anions from the resulting conductive, anion-charged polymer does not take place, and/or only to a limited extent, via a deprotonation reaction, but takes place predominantly and/or wholly via a reduction reaction,
at least one type of anions—optionally at least one salt, an ester and/or at least one acid as carrier of these anions
   wherein at least one type of anions 1. can be incorporated into the conductive polymer as doping ion into the structure of the conductive polymer, 2. can also be released again from this structure in the case of a potential drop of the conductive polymer (reduction), and 3. in the case of the presence of a metallic surface can act to prevent corrosion—hereinafter termed “mobile anti-corrosive anions”,
   wherein these may in particular be selected from anions chosen from those based on alkanoic acids, arene acids, boron-containing acids, fluorine-containing acids, heteropolyacids, isopolyacids, iodine-containing acids, silicic acids, Lewis acids, mineral acids, molybdenum-containing acids, peracids, phosphorus-containing acids, titanium-containing acids, vanadium-containing acids, tungsten-containing acids, zirconium-containing acids, their salts, their esters and their mixtures,
optionally at least one oxidising agent, wherein this at least one oxidising agent may be completely or partly omitted, in particular if at least one anion simultaneously acts as an oxidising agent and/or if electrochemical and/or photochemical polymerisation is carried out,
at least one type of particles selected from clusters, nanoparticles, nanotubes, fibrous, coil-like and/or porous structures, particles with a mean particle size in the range from 10 nm to 10 mm, and collections of these particles such as agglomerates and/or aggregates, as well as
water and/or at least one other polar solvent and optionally at least one further solvent, in particular selected from polar solvents, non-polar or weakly polar solvents and from solvents that are not liquid at room temperature but may act as solvents at higher temperatures,
   wherein a coating having a thickness of at least one monolayer is formed from the educt mixture on at least a part of the surfaces of the particles, which monolayer consists in particular either substantially of monomers and/or oligomers or at least contains a significant proportion of monomers and/or oligomers in addition to optionally at least one further component of the educt mixture,
   wherein in the dispersion, in the composition, in the sol and/or gel, or—optionally at least after partial removal of liquid—in an aerosol, at least a proportion of the monomers and/or oligomers is converted chemically by oxidation with at least one oxidising agent, electrochemically under an electrical voltage and/or photochemically under the action of electromagnetic radiation, in each case in the presence of at least one type of mobile anti-corrosive anions, at least partially to at least one oligomer and/or optionally partially or wholly to in each case at least one polymer, copolymer, block copolymer and/or graft copolymer in a mixture containing water and/or at least one other polar solvent (“product(s)”),
   wherein the oligomers, polymers, copolymers, block copolymers and/or graft copolymers formed thereby—hereinafter termed “conductive polymers”—are at least partially electrically conductive and/or become electrically more conductive.

In such a process for coating inorganic and/or organic particles, in which the particles are present in a mixture and/or are initially formed therein, and wherein the mixture is a dispersion, a flowable or kneadable composition, a sol and/or a gel, the mixture may be a product mixture and may contain:
at least one electrically “conductive polymer” based on oligomer/polymer/copolymer/block copolymer/graft copolymer,
   wherein at least one educt is then chosen for the production of at least one conductive polymer, such that the oxidation potential of the educt is less than or equal to the decomposition potential of water and/or of at least one other polar solvent in the mixture used for this purpose, and
   wherein the release of mobile anti-corrosive anions and optionally also of coupling anions from the resultant conductive polymer does not take place, and/or takes place only to a minor extent, via a deprotonation reaction, but takes place largely and/or wholly via a reduction reaction,
at least one type of anions—optionally at least a salt, an ester and/or at least an acid as carrier of these anions—wherein this at least one type of anions 1. can be incorporated and/or is at least partially incorporated into the conductive polymer as doping ion into the structure of the conductive polymer, 2. can also be released again from this structure in the case of a potential drop of the conductive polymer (reduction), and 3. in the case of the presence of a metallic surface can act to prevent corrosion—hereinafter termed “mobile anti-corrosive anions”,
at least one type of particles selected from clusters, nanoparticles, nanotubes, fibrous, coil-like and/or porous structures, particles with a mean particle size in the range from 10 nm to 10 mm, and collections of these particles such as agglomerates and/or aggregates, as well as
optionally oxidising agent, water and/or at least one other solvent,
   wherein from the product mixture a coating having a thickness of at least one monolayer is formed on at least a part of the surfaces of the particles,
   wherein the formed oligomers, polymers, copolymers, block copolymers and/or graft copolymers—hereinafter termed “conductive polymers”—are at least partially electrically conductive and/or become electrically more conductive.

Up to now no anilines, polyanilines or their derivatives are known to the applicants that act according to the invention. It is particularly preferred if the mobile anti-corrosive anions also 4. have the ability to stop an oxygen reduction in the damaged region at least at the delamination front and/or at a front running ahead, and/or 5. also act in a coupling manner so that a delamination is at least partially resealed (repair effect).

In the case of polyanilines the mobile anti-corrosive anions are not released from the conductive polymer via a reduction reaction. Since the reduction products of the polyaniline are not stable, the reduction reaction is not chosen within the context of the present invention. Rather, instead of a reduction reaction a deprotonation reaction is chosen for the release of the anions. No conductive polymers based on polyanilines are known to the applicants in which this release takes place via a deprotonation reaction.

If the oxidation potential of the educt is less than or equal to the decomposition potential of water and/or at least one other polar solvent in the mixture used for this purpose, this means that the oxidation (=polymerisation) of the conductive polymer is/becomes complete without a decomposition, for example of water, and for example the release of hydrogen occurring, or before such a decomposition or release can occur.

The term “dispersion” within the context of the present invention includes not only suspensions, but also solutions and emulsions.

It has now been found that, inter alia, molybdate anions were released on account of a potential drop in the conductive polymer which is in the damaged region, and have migrated directly to the defect. Other migration paths can be excluded in this experimental procedure. A molybdate-containing passivation layer was then formed on the metallic surface at the damaged site and was detected by X-ray spectroscopy measurements.

Furthermore, a repair effect was now detected with a scanning Kelvin probe (SKP), in which FIG. 2 of DE 102004037542 in conjunction with the measurement results disclosed in Example 1 reveal a powerful passivation effect on a damaged region. In FIG. 2 some measurement curves which were obtained between the first measurement at a very low corrosion potential and individual measurement curves from the middle of the series of measurements, have however been omitted. A very sharp potential rise of ca. 0.3 V occurs between these curves, which indicates that the delamination at a site undergoing delamination has been stopped at least to some extent. FIG. 1 shows by way of comparison the effects that generally occur.

It has also now been found that, as a result of the start of the corrosion process, a potential change with a gradient of the electrical field occurs at a site on the metal/coating interface. The release of the anions (release effect) occurs only if such a potential change takes place however. Unless there is damage to the coating, some other deleterious change to the coating or some other defect at the metal/coating interface, such as for example impurities, the anions incorporated into the conductive polymer are stored and the potential values remain constant. The electrode potential drops sharply already before and during the delamination of the metallic surface and coating, such as occurs when the coating is damaged.

This potential drop leads to a reduction of the conductive polymers, especially in the vicinity of the defect, whereby anions having anti-corrosive, passivating and/or coupling properties are released.

The potential drop may in this connection preferably exhibit on the one hand at least the values of the potential difference between the redox potential of at least one depot substance (conductive polymer) in the undamaged state and the corrosion potential of the metallic surface at a defect, so that the occurrence or progression of the delamination can be counteracted at least to some extent early or in good time, before a serious delamination occurs.

The potential drop may in this connection preferably exhibit on the other hand lower values than the values between the redox potential of at least one depot substance in the undamaged state and the corrosion potential of the metallic surface at a defect, in particular at a front with a potential difference running ahead of the delamination, so that the occurrence or progression of the delamination can be counteracted at least to some extent early or in good time before a slight or serious delamination occurs.

The redox potential of the conductive polymer is preferably higher than the passivation potential of the respective metallic material that is to be protected against corrosion by suitable coating. The redox potential is the potential that is adjusted under normal conditions in the presence of corresponding redox pairs with different degrees of doping which simultaneously exist.

The redox potential may be adjusted primarily via the degree of doping, i.e. depending on the nature and amount of the anions. In this way a potential difference in the particles according to the invention or in the coating can be purposefully adjusted. The redox potential of the conductive polymer is preferably adjusted so that it is above the potential of the passivated metallic surface and significantly above the potential of the corroding surface.

The passivation potential is the potential at the interface between the metallic surface and water, at which a closed stable passivating cover layer is formed on the metallic surface, so that a further dissolution of the metal is suppressed.

It is particularly advantageous if the oxidation potential of the anion is higher than the oxidation potential of the educt, since the anion can then at the same time act as an oxidising agent.

Furthermore it is preferred if at least one depot substance, in other words at least one conductive polymer, has a redox potential that permits an early release of anions, and if at least one depot substance has a comparatively low cation transport rate of the cations from the electrolyte, in particular from the defect and/or from the metallic surface.

Preferably the cation transport rate of the cations from the electrolyte, in particular from the defect and/or from the metallic surface, to the at least one depot substance, is less than 10⁻⁸ cm²/sec, particularly preferably less than 10⁻¹⁰ cm²/sec, most particularly preferably less than 10⁻¹² cm²/sec, and especially even less than 10⁻¹⁴ cm²/sec.

The expression “damaged region” denotes the region around the defect, in which possibly the defect, the damaged site as well as fronts of the potential change running ahead, are contained, i.e. changes of the chemical system have occurred. The “damaged site” denotes the defect including any delaminations that may possibly have occurred. A slight delamination occurs in the region of a forwardly displaced cathodic front, in which the polymer adhesion is not yet destroyed, though an oxygen reduction also often takes place at the interface. A marked delamination occurs if in addition so many radicals are also formed there that they destroy the adhesion at the interface, i.e. lead to actual delamination.

In all cases, on the one hand the anions and on the other hand the coating, in particular at least a depot substance and/or at least a matrix substance, should have such pore sizes that the chosen anions to be released are not, or are not substantially, prevented from migrating through the coating, i.e. in particular through the depot substance(s) and through further components, such as for example the matrix. A so-called matrix substance is a substance, such as for example an organic polymer/copolymer, that forms or in principle could form at least in part the matrix of a coating, wherein flowing transitions may occur between the matrix and the further components, such as for example after film forming.

The mobile anti-corrosive anions and/or the coupling anions that are possibly also present preferably have a size that enables them, in the case of a potential drop, to migrate with a high mobility from the conductive polymer in the damaged region and move in particular in the direction of the defect. Due to the purposeful migration of the anions to the damaged site, in individual chemical systems with conductive polymers a passivation, by means of which a (further) metal dissolution is suppressed, and possibly also a repair of the damaged site could be achieved (repair effect). A precondition for this migration is that the pore channels for the migrating anions, possibly including their solvate shells, are sufficiently large. In the chemical reaction at the damaged site cations are formed on dissolution of the metal, which together with the anions can locally form a passivation layer in the region of the damaged site.

However, it has hitherto been found in practice that real chemical systems containing conductive polymers almost without exception exhibit only relatively low electrical conductivities, and that the repair effects were hitherto undetectable or were so weak that they could not be used for technical purposes. It is therefore particularly preferred to select a chemical system in which also a repair effect occurs, which however obviously can only be used in some embodiments and under certain conditions. It is therefore also desirable to be able to optimise the conditions for the formation of a potential gradient (triggering of the release effect) and optionally also for the healing effect (repair effect), so that it can be employed technically. Also, the delaminated interface should be protected by the chemical system against (ongoing) corrosion.

An advantage of the use of particles containing a proportion of conductive polymer is the versatility of the use of the particles for any desired metallic surfaces or for any desired types of coatings.

Many wholly or largely organically composed coatings and also chemically differently composed coatings could be improved by an addition of conductive polymers: with a small content of electrically conductive constituents the improvement would in particular be with regard to the antistatic behaviour of the coating, while with a higher content of such constituents the improvement would in particular be with regard to an adjustable electrical conductivity, which may be significant for example for the deposition of paint components in an electrical field or possibly also for electrical welding of metal sheets coated with such layers. In very many applications a high or even improved protection of metallic surfaces against corrosion can be achieved.

Particles consisting substantially of conductive polymer, particles containing conductive polymer and/or particles as cores with a very thin, thin, thick or very thick shell (core-shell particles) of conductive polymer may often be helpful in incorporating conductive polymers into a composition, dispersion or solution in particulate, low-viscosity or high-viscosity form.

### Composition for Coating Metallic Surfaces:

The composition for forming the coating containing the conductive polymer on and/or in particles, may be composed in various ways on metallic surfaces, depending on whether a) in a simple composition corresponding to claim 1 a composition is involved that always contains at the same time particles containing conductive polymer, and a binder system, b) in a first composition corresponding to claim 2 a composition is involved that always contains particles containing conductive polymer, or c) in a second composition corresponding to claim 2 a composition is involved that always contains a binder system. Nevertheless, in the case of b) and/or c) it is not excluded that each of the compositions in the case of b) additionally also contains a proportion of binder system and/or additives in addition to at least one solvent, or in the case of c) in addition also contains a proportion of particles containing conductive polymer, and/or additives in addition to at least one solvent.

The composition for the formation of the coating containing conductive polymer on and/or in particles, on metallic surfaces preferably contains:

In case a):
At least one type of particles containing conductive polymer, optionally as at least one type of inorganic and/or organic particles which are coated with conductive polymer and/or contain conductive polymer in their interior, with a total content of particles containing conductive polymer preferably in the range from 0.5 to 90 wt. %, particularly preferably in the range from 5 to 80 wt. %, wherein the at least one conductive polymer is selected from the group of conductive polymers consisting of oligomers, polymers, copolymers, block copolymers and/or graft copolymers with a content of conductive polymers preferably in the range from 0.1 to 30 wt. %, particularly preferably in the range from 0.5 to 20 wt. %, in which at least one type of mobile anti-corrosive anions is incorporated,
a binder system that contains at least one organic polymer selected from the group of organic polymers consisting of oligomers, polymers, copolymers, block copolymers and graft copolymers preferably with a content in the range from 5 to 99 wt. %, particularly preferably in the range from 10 to 95 wt. %, and
optionally at least one additive preferably with a content in the range from 0.1 to 30 wt. %, particularly preferably in the range from 1 to 20 wt. %,
wherein all these contents, including possibly further additives not mentioned here, but excluding solvents, total 100 wt. %, as well as
at least one solvent, the total amount being in excess of 100 wt. %.

In case b):
At least one type of particles containing conductive polymer, optionally as at least one type of inorganic and/or organic particles which are coated with conductive polymer and/or contain conductive polymer in their interior, with a total content of particles containing conductive polymer preferably in the range from 10 to 100 wt. %, particularly preferably in the range from 20 to 99 wt. %, wherein the at least one conductive polymer is selected from the group of conductive polymers consisting of oligomers, polymers, copolymers, block copolymers and/or graft copolymers with a content of conductive polymers preferably in the range from 0.1 to 100 wt. %, particularly preferably in the range from 5 to 60 wt. %, in which at least one type of mobile anti-corrosive anions is incorporated,
optionally a binder system that contains at least one organic polymer selected from the group of organic polymers consisting of oligomers, polymers, copolymers, block copolymers and graft copolymers preferably with a content in the range from 0.1 to 90 wt. %, particularly preferably in the range from 1 to 80 wt. %, and
optionally at least one additive preferably with a content in the range from 0.1 to 30 wt. %, particularly preferably in the range from 1 to 20 wt. %,
wherein all these contents, including possibly further additives not mentioned here, but excluding solvents, total 100 wt. %, as well as
at least one solvent, the total amount being in excess of 100 wt. %.

In case c):
a binder system that contains at least one organic polymer selected from the group of organic polymers consisting of oligomers, polymers, copolymers, block copolymers and graft copolymers, preferably with a content in the range from 10 to 100 wt. %, particularly preferably in the range from 40 to 95 wt. %,
optionally at least one type of particles containing conductive polymer, optionally as at least one type of inorganic and/or organic particles that are coated with conductive polymer, and/or contain conductive polymer in the interior, with a total weight of particles containing conductive polymer preferably in the range from 0.1 to 50 wt. %, particularly preferably in the range from 1 to 30 wt. %, wherein the at least one conductive polymer is selected from the group of conductive polymers consisting of oligomers, polymers, copolymers, block copolymers and/or graft copolymers with a content of conductive polymers preferably in the range from 0.1 to 30 wt. %, particularly preferably in the range from 0.5 to 20 wt. %, in which at least one type of mobile anti-corrosive anions are incorporated, and
optionally at least one additive, preferably with a content in the range from 0.1 to 30 wt. %, particularly preferably in the range from 1 to 20 wt. %,
wherein all these contents, including possibly further additives not mentioned here, but without solvent, comprise in total 100 wt. %, as well as
at least one solvent, the total amount being above 100 wt. %.

Preferably the content of at least one type of particles containing conductive polymer in the composition a), b) and/or c) is in the range from 1 to 99 wt. %, in the range from 5 to 95 wt. %, in the range from 10 to 90 wt. %, in the range from 15 to 85 wt. %, in the range from 20 to 80 wt. %, in the range from 25 to 75 wt. %, or in the range from 30 to 70 wt. %, particularly preferably in the range from 35 to 65 wt. %, in the range from 40 to 60 wt. % or in the range from 4.5 to 55 wt. %. In this connection the particularly preferred ranges may also be displaced to smaller or larger values, in particular depending on whether a composition a), b) and/or c) is involved, and on whether predominantly or wholly, coated inorganic particles, organic particles containing conductive polymer are involved, or whether predominantly or wholly particles containing conductive polymer are involved.

Preferably the content of at least one conductive polymer in the composition a), b) and/or c) is in the range from 0.1 to 99 wt. %, in the range from 0.5 to 95 wt. %, in the range from 1 to 90 wt. %, in the range from 1.5 to 85 wt. %, in the range from 2 to 80 wt. %, in the range from 2.5 to 75 wt. %, or in the range from 3 to 70 wt. %, particularly preferably in the range from 3.5 to 65 wt. %, in the range from 4 to 60 wt. % or in the range from 4.5 to 55 wt. %, possibly particularly preferably in the range from 5 to 60 wt. %, in the range from 10 to 55 wt. %, in the range from 15 to 50 wt. %, in the range from 20 to 45 wt. %, in the range from 20 to 40 wt. %, or in the range from 30 to 35 wt. %. In this connection the particularly preferred ranges may also be displaced to smaller or larger values, in particular depending on whether a composition a), b) and/or c) is involved, and whether predominantly or wholly, coated inorganic particles, organic particles containing conductive polymer are involved or whether predominantly or wholly particles containing conductive polymer are involved.

Preferably the content of binder system in the composition a), b) and/or c) is in the range from 1 to 99 wt. %, in the range from 5 to 96 wt. %, in the range from 10 to 92 wt. %, in the range from 15 to 88 wt. %, in the range from 20 to 84 wt. %, in the range from 25 to 80 wt. % or in the range from 30 to 76 wt. %, particularly preferably in the range from 35 to 72 wt. %, in the range from 40 to 68 wt. %, in the range from 45 to 64 wt. % or in the range from 50 to 60 wt. %. In this connection the particularly preferred ranges may also be displaced to smaller or larger values, in particular depending on whether a composition a), b) and/or c) is involved, and on whether, predominantly or wholly, coated inorganic particles, organic particles containing conductive polymer or predominantly or wholly particles containing conductive polymer are involved. Optionally added organic monomers, thermal crosslinking agents and/or photoinitiators are likewise included among the constituents of the binder system.

Preferably the content of solvent(s) in the composition a), b) and/or c), exceeding the content of solids=100 wt. %, is in the range from 2 to 4000 wt. %, in the range from 1 to 2500 wt. %, in the range from 5 to 3000 wt. %, in the range from 10 to 800 wt. %, in the range from 2 to 300 wt. %, in the range from 20 to 2500 wt. % or in the range from 30 to 600 wt. %, particularly preferably in the range from 1 to 1500 wt. %, in the range from 2 to 1200 wt. % or in the range from 50 to 600 wt. %, most particularly preferably in the range from 30 to 400 wt. %, in the range from 5 to 160 wt. %, or in the range from 5 to 80 wt. %.

The weight ratio of the constituents in the composition a), b) and/or c) between (particles containing conductive polymers):(binder system) is in many embodiment variants preferably 1:(0.05 to 30) and particularly preferably 1:(0.5 to 20). In this case too the particularly preferred ranges may also be displaced to smaller or larger values, in particular depending on whether a composition a), b) and/or c) is involved and on whether predominantly or wholly, coated inorganic particles, particles containing conductive polymer are involved, or whether predominantly or wholly particles containing conductive polymer are involved.

The contents of these constituents in these compositions may in principle be varied within wide limits. The variation depends in particular on the thickness of the coating: ultra-thin, thin, thick or very thick coatings may be applied, which may for example have a layer thickness in the range from 0.5 to 10 nm, from >1 to 100 nm, from >10 to 1000 nm (1 μm), from >100 nm to 10 μm, or from >0.5 μm to 50 μm. If inorganic and/or organic particles are used, the volume ratio and weight ratio may decrease significantly from the particle cores to the conductive polymer. Constituents having a low or high density may also be chosen. In addition, the specific surface of the inorganic particles may also decrease very sharply, as for example in the case of SiO₂ powders that are produced by flame hydrolysis.

If particles that substantially or wholly contain conductive polymer, and which consist largely or wholly of conductive polymer are added to the composition, then the proportion of these particles is preferably maintained low. The proportion of particles containing conductive polymer will generally increase markedly, the larger the particles and/or the smaller the ratio of conductive polymer to particle cores.

It has been found from preliminary experiments that for many coatings according to the invention it is advantageous to use particles containing conductive polymer which have a mean particle size in the range from 10 to 200 nm, in particular in the case of inorganic and/or organic particles. The ratio of the contents of conductive polymer to the contents of inorganic and/or organic particle cores may in this connection also be varied within wide limits, preferably in the range from 1:(0.05 to 20) and particularly preferably 1:(0.2 to 5).

Furthermore the conductive polymer and the particles containing conductive polymer may optionally also contain a minor content or traces of in each case at least one surfactant, a protective colloid, an acid trap and/or a complex-forming agent. If necessary there may be added to the composition a), b) and/or c) in each case at least one additive, optionally at least one surfactant, such as for example in each case at least one non-ionic, anionic and/or amphoteric surfactant, at least one protective colloid, such as for example a polyvinyl alcohol, at least one acid trap such as for example ammonia or a weak base such as for example an acetate, and/or at least one complex-forming agent such as for example ammonia, citric acid, EDTA or lactic acid. The content of the at least one surfactant is preferably 0.01 to 1.5 wt. %. The content of the at least one protective colloid, the at least one acid trap and/or the at least one complex-forming agent is in each case preferably 0.01 to 0.8 wt. %.

### Processor Technology Variants in the Production of the Composition and the Coating:

Particles containing conductive polymer may if necessary—specifically in the dry state—be washed, dried and/or heated before the dispersion or before addition to the composition. A mixture with a relatively high water content or only water is preferably added as solvent. In a number of variants it is however advantageous or necessary to add a small amount of organic solvent, in particular at least one alcohol, especially 1 to 10 wt. % of at least one alcohol such as for example ethanol, propanol and/or isopropanol.

It is particularly preferred to add the inorganic and/or organic particles not in the dry state but as a dispersion, to the composition. In this connection it is advantageous if the dry powders contain charges that are distributed in the solvent and contribute to the stabilisation of the dispersion. The stable dispersion of the inorganic and/or organic particles may in this connection take place with or without an addition of charge carriers. The redispersion may be carried out for example with a dissolver, ball mill, bead mill and/or an ultraturrax machine. In this connection it is advantageous if the particle surfaces are partially or as far as possible completely wetted with binder. It is most particularly preferred if the particle-containing dispersion is added to a dispersion that has a similar pH value to the remaining composition that is partially or completely prepared in this stage. It is also most particularly preferred if the binder of the binder system and/or the particles containing conductive polymer, in particular the organic particles, are added in such a way that substantially no or virtually no chemical reaction and/or polymerisation, in particular of the organic constituents of the composition, takes place in the said composition until the release of significant proportions of solvent, such as for example water.

In some embodiment variants, when mixing the constituents together to form the composition the at least one liquid and the inorganic and/or organic particles are first added, followed by the binder system.

Preferably all constituents that are mixed together to form the composition are in each case added in the form of a solution and/or dispersion to the composition.

In other embodiment variants, when mixing the constituents together to form the composition containing at least one solvent, portions of the binder system and possibly also the additives or even the whole binder system are first of all taken before the inorganic and/or organic particles are added. It is particularly preferred to add initially only 3 to 25 wt. % of the solids contents of the binder system to the composition, which already contains the inorganic and/or organic particles and/or which are then added at this stage to the composition. In this stage the rheology of the dispersion can if necessary be adapted and/or adjusted and/or the composition can be subjected to shear forces, e.g. by grinding.

If first of all the whole binder system is added to the composition, it may then be advantageous first of all to match and/or adjust the rheology of the composition and then add the inorganic and/or organic particles.

### Mobile Anti-Corrosive Anions:

Mobile anti-corrosive anions have the task of providing in the conductive polymer and in the composition of the coating of the product the charges necessary for the charge compensation of the electrophilic centres formed on the polymer chains in the oxidation, as well as of producing an initial anti-corrosive action by adsorption on metallic surfaces.

If no anions are added to an educt mixture in the preparation of the conductive polymer, the said conductive polymer will incorporate into its lattice any ions that are present in the dispersion, but however then cannot incorporate mobile anti-corrosive anions. Often more porous, thinner and less electrically conducting layers are then formed, if at all, on the particles.

When an anion is added in the vast majority of investigations of the prior art concerning the production and use of conductive polymers, as a rule the electrical neutrality of the conductive polymer is achieved during the formation. In addition specific properties of the conductive polymer, such as for example the electrical or ionic conductivity as well as the morphology and the work function (oxidation potential) are influenced by the anion. It has now been recognised that an anti-corrosive effect can also be achieved by the anion.

The at least one anion preferably has a water solubility or a solubility in the at least one polar solvent or solvent mixture of at least 1×10⁻³ mol/l, since otherwise the anion can also no longer be incorporated into the conductive polymer (=salt).

However, also at least one mobile anti-corrosive anion that simultaneously acts as an oxidising agent, such as molybdate and/or tungstate, may additionally or alternatively to the mobile anti-corrosive anion(s) not exhibiting an oxidising effect, be incorporated into the conductive polymer.

In the process according to the invention at least one type of the anti-corrosive mobile anions is preferably at least one based on benzoate, carboxylate such as for example lactate, dithiol, fumarate, complex fluoride, lanthanate, metaborate, molybdate, a nitro compound, for example based on nitrosalicylate, octanoate, phosphorus-containing oxy anions, such as e.g. phosphate and/or phosphonate, phthalate, salicylate, silicate, sulfoxylate, such as for example formaldehyde sulfoxylate, thiol, titanate, vanadate, tungstate and/or zirconate, particularly preferably at least one anion based on titanium complex fluoride and/or zirconium complex fluoride, in each case as MeF₄ and/or MeF₆, in which connection other stoichiometric ratios may also occur.

In the process according to the invention a mixture of anions is preferably used as the at least one type of corrosion-inhibiting or coupling anions, particularly preferably a mixture based on at least one of the aforementioned anti-corrosive mobile anions and phosphonate, silane, siloxane, polysiloxane and/or surfactant, in particular with at least one complex fluoride, titanate, zirconate, molybdate and/or tungstate.

The anions that can oxidatively be incorporated into the depot substance(s) may in particular be selected from those based on alkanoic acids, arene acids, boron-containing acids, fluorine-containing acids, heteropolyacids, isopolyacids, iodine-containing acids, silicic acids, Lewis acids, mineral acids, molybdenum-containing acids, peracids, phosphorus-containing acids, titanium-containing acids, vanadium-containing acids, tungsten-containing acids, zirconium-containing acids, their salts, their esters and their mixtures.

Preferably the at least one mobile anti-corrosive anion is added in an amount of 1 to 33 mol % with reference to the contents of the polymer unit, preferably in an amount of 5 to 33 mol %. These added amounts correspond to the degrees of doping of the conductive polymers. On the other hand these anions may also be added in excess in the preparation of the conductive polymer.

At least one type of anions may in particular be chosen such that these anions are mobile in water, in at least one other polar solvent and/or in a mixture also containing at least one non-polar salt.

In addition to the at least one mobile anti-corrosive anion at least one anion without an anti-corrosive action and/or without the ability to be incorporated into the structure and/or to be able to migrate from the structure, may however also be present in, and/or in addition to, the conductive polymer. The proportion of such anions should however often preferably be not too large compared to the so-called mobile anti-corrosive anions. In some cases a further anion is also introduced together with the oxidising agent, such as for example the oxidising agent peroxodisulfate, which is often required for the oxidation of the educts to conductive polymers. If however for example H₂O₂ and Fe^{2+/3+} salt is used as oxidising agent, no additional anion is introduced if the Fe^{2+/3+} salt is added in catalytic amounts of at most less than 10⁻⁴ mol/l. The proportion of anions belonging to the mobile anti-corrosive anions should in many embodiment variants be chosen to be as high as possible in order to achieve a good anti-corrosive effect.

In the preparation of the conductive polymer, in particular all types of mobile anti-corrosive anions are preferably chosen so that these anions are not too large, in order not to interfere in the mobility of these anions in the conductive polymer and in neighbouring substances. Preferably an anion such as for example molybdate is chosen, which is smaller than in particular polystyrene sulfonate, since the latter is as a rule too large for the mobility and can then be employed only as a firmly incorporated anion.

Preferably the at least one mobile anti-corrosive anion has a diameter that is not larger than the mean pore size of the pore system of the conductive polymer, this diameter preferably being at least 8% smaller or even at least 15% smaller than the mean pore size of the pore system. In this connection the anion may be mobile due to a very large proportion of pores, for example pore channels, in particular in the conductive polymer, and can thereby possibly migrate more quickly or indeed even migrate in the first place. An anion that is very much smaller than the mean pore size of the pore system can also migrate with a higher probability unhindered or less hindered through the pore system, if a potential difference exists due to the gradient of the difference of the redox potential of the conductive polymer and the corrosion potential of the corroding metal.

If in the process according to the invention binder-rich coatings are produced, the mobile anti-corrosive anion should have such a small size that its mobility is not, or is not substantially, hindered also in the other constituents of the coating. These anions migrate in the event of a corrosive attack to the damaged region, which almost always has a lower potential than the intact interface.

Preferably the at least one mobile anti-corrosive anion is selected from anions based on carboxylic acids, hydroxycarboxylic acids, oxycarboxylic acids, dicarboxylic acids, tricarboxylic acids, di-substituted and/or tri-substituted arenecarboxylic acids, meta- ortho- and/or para-substituted arenecarboxylic acids, arene acids containing amino, nitro, sulfonic (SO₃H—) and/or OH groups, sulfonic acids, mineral oxyacids, boron-containing acids, manganese-containing acids, molybdenum-containing acids, phosphorus-containing acids, phosphonic acids, fluorosilicic acids, silicic acids, acids with a content of at least one element from the rare earths and/or yttrium, such as for example cerium-containing acids, sulphur-containing acids, titanium-containing acids, vanadium-containing acids, tungsten-containing acids, tin-containing acids, zirconium-containing acids, their salts, their esters and their mixtures.

Preferably the at least one anion is selected from anions based on alkylphosphonic acids, arylphosphonic acids, benzoic acid, succinic acid, tetrafluorosilicic acid, hexafluorotitanic acid, hexafluorozirconic acid, gallic acid, hydroxyacetic acid, silicic acids, lactic acid, molybdenum acids, niobic acid, nitrosalicylic acids, oxalic acid, phosphomolybdic acid, phosphoric acid, phosphorosilicic acid, phthalic acids, salicylic acid, tantalic acid, vanadium acids, tartaric acids, tungstic acids, their salts, their esters and their mixtures.

In many cases the electrical conductivity of the coating on the particles and thus also the electrical conductivity of the coating on the metallic surface is increased by the addition of the at least one mobile anti-corrosive anion, which can adopt different valency states and can thus readily change to other valency states.

Anions may also be incorporated that undergo a valency change and/or undergo a ligand exchange (co-ordination change) in the damaged region, such as for example a ligand exchange in the case of hexafluorotitanate and/or hexafluorozirconate. A change of solubility is advantageously also associated therewith, which means that the originally soluble anion precipitates in the damaged region and forms an anti-corrosive layer. The valency change may occur as an oxidation or reduction. Preferably such layers are oxide layers and/or layers of sparingly soluble salts. If hexafluorotitanate and/or hexafluorozirconate are used, it has been found to be advantageous to add hydrofluoric acid to the mixture used for the preparation of the conductive polymer.

It has now been found experimentally that the at least one mobile anti-corrosive ion, such as for example TiF₆²⁻, ZrF₆²⁻, CeO₄⁴⁻, MnO₄—, MnO₄²⁻, MoO₄²⁻, MoO₄⁴⁻, VO₄²⁻, WO₄²⁻, WO₄⁴⁻ undergoes a ligand exchange or a change in valency and/or solubility, and an oxidic protective layer is formed in the region of the defect and/or in the region of the delamination front. Such anions, just like most complex salts, are particularly advantageous.

In delamination experiments carried out in an N₂ atmosphere it was now found that molybdate ions are in fact released in a potential-driven manner from a conductive polymer based on polypyrrole and migrate to the defect, where the molybdate has been detected by X-ray spectroscopy.

In the preparation of the conductive polymer preferably at least one anion based on phosphorus-containing oxy anions, such as for example phosphonate, silane, siloxane, polysiloxane and/or surfactant, may also be added as at least one type of the coupling anions to the mixture.

Preferably a mixture of at least two types of anions may also be incorporated into the depot substance as the at least one type of corrosion-inhibiting and/or coupling anions, particularly preferably an anion based on at least one type of the aforementioned anti-corrosive mobile anions with at least one type of the aforementioned coupling anions, in particular selected from those anions based on carboxylate, complex fluoride, molybdate, nitro compound, based on phosphorus-containing oxy anions such as for example phosphonate, polysiloxane, silane, siloxane and/or surfactant, most particularly preferably an anion based on at least one of the aforementioned anti-corrosive mobile anions with at least one type of the aforementioned coupling anions. In particular a mixture of types of anions is then incorporated, selected from types of anions on the one hand based on carboxylate, complex fluoride, molybdate and nitro compound, and on the other hand based on phosphorus-containing oxy anions, polysiloxane, silane, siloxane and/or surfactant.

It is particularly preferred to select anions which, in a similar way to chromate, form protective substances that protect the damaged region—at least partially—both anodically as well as cathodically. In this connection anions are preferably chosen that can undergo a change of valency, and/or complex anions that can decompose.

Also, anions of subgroup elements with higher oxidation states, such as for example 4+ or 6+, are particularly preferably incorporated, in particular oxy anions. These can produce a particularly good anti-corrosive effect on a metallic surface to be protected if this surface is provided with an organic coating that contains conductively coated particles.

With anti-corrosive anions it is advantageous if these form, together with the cations present in the damaged region, such as for example the cations dissolved out from the metallic surface by the corrosion, a passivation layer that is as compact and as sealed as possible on the metallic surface, in which the at least one formed substance of the passivation layer is not ionically conductive and is stable at the pH range employed at the interface. These substances may for example be oxides, hydroxides and phosphates, or their mixtures.

Often the electrical conductivity of the coating to be formed is increased by increasing the concentration of the at least one mobile anti-corrosive anion in the conductive polymer. Preferably the ratio of the content of the at least one anion incorporated into the conductive polymer to the content of originally used educt(s) (=degree of doping) is at least 1 mol %, preferably at least 5 mol %, particularly preferably at least 10 mol %, most particularly preferably at least 15 mol %, and especially at least 20 mol %. Theoretically 50 mol % could be achieved, though in practice this is obviously not implemented.

### Oxidising Agents

Oxidising agents in the educt mixture used for the production of the conductive polymer have the task of starting the chain synthesis that takes place for example according to a cationic/free-radical mechanism, and maintaining this despite consumption of materials.

Oxidising agents are therefore added to the educt mixture as a rule preferably in amounts in excess of 33 mol %. For the conversion of the at least one educt (monomers and/or oligomers that are capable of forming a depot substance, i.e. conductive polymer with incorporated anions) into at least one product (=conductive polymer), anions are necessary for the electrical neutrality of the conductive polymer and possibly oxidising agents are necessary for the polymerisation. Preferably at least one oxidising agent is added, particularly if at least one anion could not also simultaneously act as an oxidising agent and/or is not electrochemically and/or photochemically polymerised.

The oxidising agent for the chemical conversion may be at least one based on H₂O₂, such as for example barium peroxide, peracetic acid, perbenzoic acid, permanganic acid, peroxomonosulphuric acid, peroxodisulfuric acid, Lewis acid, molybdic acid, niobic acid, tantalic acid, titanic acid, tungstic acid, zirconic acids, yttrium-containing acid, lanthanide-containing acid, Fe³⁺-containing acid, Cu²⁺-containing acid, their salts, their esters and/or their mixtures.

As oxidising agent there may for example be used at least one compound based on acid(s), their salt(s) present in multiple valency states, such as for example iron salt(s), or based on peroxide(s) and/or peracid(s), such as for example peroxodisulfate.

With oxidising agents that can adopt a plurality of valencies and can change these valencies more or less easily, it is then often necessary to choose a suitable, generally somewhat lower or average pH value. The pH values are then in many cases in the range from 2 to 6, in particular in the range from 2 to 4 or 3 to 5. It is also important to ensure that the oxidation potential of the oxidising agent is higher than the oxidation potential of the educt to be oxidised or that it is at least of the same magnitude.

Preferably the particles containing conductive polymers which are added to the composition according to the invention are free, or substantially free, of oxidising agents.

### Particles Containing Conductive Polymer:

The composition, the contents and the structure of the organic and/or inorganic particles may vary within wide ranges.

The mean size of the particles should be counted in the range down to 0.1 μm mean size in the scanning electron microscope, with suitable preparation under separate evaluation and counting of the individual parts of agglomerates and evaluation and counting of agglomerates as a large individual particle, while the mean size in the particle size range from 5 nm to less than 0.1 μm should be determined with a Zeta-Sizer type laser Doppler anemometer from Malvern Instruments, while for even smaller mean particle sizes electron diffraction is preferred for the determination. In this connection an approximation for the particles detected by scanning electron microscopy can be obtained if divisible agglomerates that contain separable individual particles are in each case evaluated and counted as a plurality of individual particles, which to some extent may correspond to the action of a gentle grinding.

The size of the organic and/or inorganic particles should as a rule not change significantly during the coating of the particles and as far as possible also in the production, application and drying of the composition and/or during the subsequent treatments of the coating on metallic surfaces.

The particles may if necessary be precoated, chemically modified and/or physically modified. Thus, in the case of SiO₂ particles for example a distinction may be made between acidic and basic, hydrophilic and hydrophobic particles.

In this connection the particles may be present in at least one form selected from: substantially in the form of clusters, nanoparticles, nanotubes, in each case roughly in the shape of isometric, fibre-shaped, needle-shaped, platelet-shaped, disc-shaped and/or coiled particles, in each case roughly in the form of fibrous, coil-like and/or porous structures, solid particles, as coated and/or filled particles, as hollow particles and/or as sponge-like particles. Particularly preferred in each case are substantially planar or linear-shaped barrier particles and/or coated pigments, such as for example coated phyllosilicates.

In particular in the case of inorganic clusters, nanoparticles or small particles as well as those containing conductive polymers, it is advantageous to suppress the tendency to agglomeration by suitable measures, such as for example addition of pyrophosphate to the aqueous dispersion of the mixture, and to disperse the mixture thoroughly.

In particular the inorganic particles may if necessary be ground, dried, annealed and/or redispersed before the addition of a liquid or before the addition to the mixture for the reaction to form conductive polymers, or to the composition for the coating of metallic surfaces in the substantially or completely dry state, or to a liquid dispersion.

The layer thickness of the layer of the conductive polymer on the particles may be varied within wide ranges. Preferably the layer thicknesses and/or the parts in the interior of the particles are in the range from 1 to 200 nm, particularly preferably in the range from 2 to 100 nm, but especially in the range from 1 to 40 nm or from 3 to 80 nm. These layers are if necessary in the case of inorganic particles formed thinner than in the case of organic particles. Thicker layers are of course in principle conceivable and possible, but could be limited if the coated particles can no longer be dispersed. The layer thickness of these shells depends in particular on the reaction time, the concentration of the educts and on the interfaces available between particles and liquid components of the educt mixture.

Advantageously coated inorganic particles are however often redispersed in a different way to coated organic particles before the mixing with the binder-containing matrix, in particular if agglomerates and/or aggregates are present. Inorganic particles are however suitable as cores for the coating with conducting polymers since they can be incorporated in a simple way, for example into an organic composition such as for example a paint, inter alia by mixing and/or gentle grinding.

In a mixture according to the invention or in a composition for coating metallic surfaces with particles, in each case at least one of the following types of particles containing conductive polymer may be present:
1) Typical core-shell particles (coated particles), which are partially or completely coated with conductive polymer, these particles frequently being inorganic coated particles,
2) Particles that contain conductive polymer at least partially in the interior or also in the interior, these particles frequently being organic particles, which often have been produced together with the conductive polymer,
3) Conductive polymer, which can be formed or produced in an arbitrary manner, which is present in particulate form and has possibly been formed separately and/or without exception not around a particle core, i.e. has not been formed as a coating on particles; conductive polymer may possibly also occur in the particles that are to be coated, in particular also where these are still growing, coalescing, and/or healing,
4) So-called “coupling agent particles” of conductive polymer, which contains at least one chemical group on the molecule promoting bonding, such as for example a phosphonate group,
5) Fractions a) of particle shells of conductive polymer and/or b) of particles containing conductive polymer and/or,
6) Conductive polymer-containing particles formed separately without particle cores, and consisting substantially or wholly of conductive polymer.

The particles containing conductive polymer are in particular selected from the group consisting of 1) typical core-shell particles (coated particles), which are partially or completely coated with conductive polymer, 2) particles that contain conductive polymer at least partially in the interior, such as many organic particles, 3) particles substantially or wholly of conductive polymer, which may be formed and produced in an arbitrary manner, 4) so-called “coupling agent particles” of conductive polymer, which contains at least one chemical group on the molecule promoting bonding, such as for example a phosphonate group, 5) fractions of particle shells of conductive polymer and/or of particles containing conductive polymer, and 6) particles formed separately without particle cores and containing conductive polymer, which consist substantially or wholly of conductive polymer.

The mean particle size of the particles containing conductive polymer including their assemblages such as agglomerates and/or aggregates is preferably in the range from 10 nm to 20 μm and/or without agglomerates and without aggregates is in the range from 10 nm to 10 μm. In the latter case the particles or the composition containing them may have been suitably comminuted, for example by grinding, and/or the agglomerates and aggregates may not have been counted in the determination of the particle sizes.

All such particles may optionally also be incorporated into the coating according to the invention. They are covered within the context of the present invention by the term “coated particles” or “particles containing conductive polymer”. The content of these individual types of particles may be relatively small or large. The details as regards the coating process apply as appropriate also to all these other variants of “coated particles”.

Organic Particles with a Content of Conductive Polymer:

In the material of the organic particles, the term “polymer” is understood to mean at least one polymer selected from homopolymer(s), copolymer(s), block copolymer(s) and/or graft copolymer(s). These polymers may consist of dispersible and/or non-dispersible particles. These particles may be used as cores for core-shell particles. In particular in the preparation of the organic particles it may also happen that the conductive polymer is incorporated partly, largely or completely in the interior of these particles, in which connection such particles are also regarded here as “coated particles” and as core-shell particles within the meaning of this application.

In particular the organic polymers consist substantially of the following polymers:

The organic particles containing conductive polymer are preferably largely or wholly those that are selected from the group consisting of polymers based on styrene, acrylate, methacrylate, polycarbonate, cellulose, polyepoxide, polyimide, polyether, polyurethane, siloxane, polysiloxane, polysilane and polysilazane.

1. Polymers based on styrene, acrylate and/or methacrylate, the last two variants being termed hereinafter (meth)acrylate. The polymers may in particular consist substantially of (meth)acrylate(s) selected from meth(acrylate), butyl (meth)acrylate, hydroxy (meth)alkyl acrylate, glycidyl (meth)acrylate and ethylene glycol (meth)acrylate and/or substantially of styrene and/or substantially of substituted styrenes, in each case independently of one another with substituents such as for example hydroxide, alkyl, alkoxy and/or sulfonate.

2. Polymers based on polycarbonate: they may in particular consist substantially of organic carbonate(s) based on bisphenol A, B, C, F and/or Z and optionally substituted for example with alkyl, alkoxy and/or aryl.

3. Polymers based on cellulose: they may in particular consist substantially of cellulose(s) selected from alkyl-cellulose and hydroxylalkylcellulose, optionally substituted with substituents such as for example hydroxide, alkyl, alkoxy, carboxylate and/or sulfonate.

4. Polymers based on polyepoxides: they may in particular consist substantially of epoxide(s) selected from unsubstituted epoxide(s) and/or from epoxide(s) substituted with substituents such as for example hydroxide, alkyl, alkoxy and/or sulfonate.

5. Polymers based on polyolefins: they may in particular consist substantially of polyolefin(s) selected from ethylene(s), propylene(s), isobutylene, butylenes(s) and 4-methylpentene and/or of at least one polyolefin substituted with substituents such as for example alkyl, amino and/or hydroxy.

6. Polymers based on polyimide: they may in particular consist substantially of polyimide(s) selected from unsubstituted polyimide(s) and/or from polyimide(s) substituted with substituents such as for example hydroxide, alkyl, alkoxyl and/or sulfonate.

7. Polymers based on polyethers: they may in particular consist substantially of epoxides selected from ethylene oxide(s) and propylene oxide(s) and/or of epoxides substituted with substituents such as for example alkyl, aryl, amino and/or chloride.

8. Polymers based on polyurethane: they may in particular consist substantially of polyurethane(s) selected from unsubstituted polyurethane(s) and/or from polyurethane(s) substituted with substituents such as for example hydroxide, alkyl, alkoxy and/or sulfonate. They may be produced in particular via diisocyanates and diols or via diisocyanates and primary/secondary diamines, in which hydroxy-terminated diols, polyesters, polyethers, polycarbonates and/or oligo(meth)acrylate may be used as diols, and alkyldiamines where n=5 to 12 may in particular be used as diamines.

9. Polymers based on siloxanes and/or polysiloxanes, and also on silicones: they may in particular consist substantially of unsubstituted and/or substituted siloxanes and/or polysiloxanes with substituents such as for example hydroxide, alkyl, alkoxy, amino, mercapto and/or sulfonate.

10. Polymers based on polysilanes and/or polysilazanes: they may consist substantially of unsubstituted and/or substituted polysilanes and/or polysilazanes with substituents such as for example hydroxide, alkyl, alkoxy and/or sulfonate. For example, they may consist substantially of poly(cyclohexylmethyl)silane(s), poly(dihexyl)silane(s) and/or poly(phenylmethyl)silane(s) and/or substantially of poly(1,2-dimethyl)silazane(s) and/or poly(1,1-dimethyl)silazane(s).

However, in particular cores based on dispersible organic polymers such as for example polyacrylates, polystyrenes, polyurethanes and/or polysiloxanes are suitable for the coating of organic particles or for their production together with the production of conductive polymer, so that the organic particles produced therefrom often have an increased proportion of conductive polymer in their interior. These polymers may also be treated in a process for the coating of organic polymers with conductive polymer, in which the organic particles are first of all produced—in particular in the same solution or dispersion and/or in the same sol or gel—following which these organic particles are coated according to the invention, or in which the organic particles and the conductive polymer are produced substantially simultaneously or simultaneously, so that the particles formed therefrom often have inclusions of conductive polymer in their interior and in some cases also conductive polymer on the surface. This process is preferably a one-pot process and/or a substantially continuous process. The production of the organic particles is in this connection preferably based on emulsion polymerisation, in particular free of surfactants. The processes, possibilities and products of the emulsion polymerisation are in principle known. These emulsion-polymerised organic particles are, on account of their previous production, normally present in the form of a stable dispersion.

It is particularly advantageous in many embodiments to produce the organic particles together with the conductive polymer. In this case it is possible to produce particles with defined narrow particle size distributions, with monomodal or bimodal particle size distributions and/or particles in which organic polymer and conductive polymer are intimately mixed with one another or have coalesced. In this connection monomodal or bimodal distributions in the size range from 30 to 400 nm may for example be formed. Organic particles may however also first of all be produced, which are then coated or are coated only in a later phase with conductive polymer, and/or are mixed in the region close to the surface.

In the production of organic particles care should be taken to ensure that the formation of micelles is not seriously affected, which in particular is possible due to an unsuitable oxidising agent, to too high contents of ions, and/or to excessively vigorous stirring. In fact, the organic particles are in this connection formed in many embodiments from micelles. Here too the chemical compatibility of the components to be added should be carefully checked. The polymerisation may also in this case take place chemically, electrochemically and/or photochemically.

In principle it is possible to coat all types of organic particles according to at least one coating process with conductive polymers, if necessary by encapsulation of poorly dispersible or non-dispersible particles. Dispersible in the context of this section of the text means that it is possible to have a stable dispersion of the organic particles in a solution or dispersion and/or in a sol or gel, so that substantially no agglomerations occur.

Inorganic Particle as Cores for Coated Particles:

Preferably the inorganic particles consist substantially of at least one inorganic substance, in particular substantially of in each case at least one boride, carbide, carbonate, cuprate, ferrate, fluoride, fluorisilicate, niobate, nitride, oxide, phosphate, phosphide, phosphosilicate, selenide, silicate, aluminium-containing silicate, sulfate, sulphide, telluride, titanate, zirconate, of at least one type of carbon, of at least one powdered mineral, of at least one powder of glass, frit, agglomerate, glass-like material, amorphous material and/or composite material, of at least one alloy and/or of at least one metal—as long as the alloy and/or the metal does not already corrode in the production of the conductive polymer and does not form any local element—and/or their mixed crystals, their intergrowths and/or their mixtures.

The organic particles may consist substantially of at least one substance, in particular substantially of in each case at least one alkaline earth carbonate, alkaline earth titanate, alkaline earth zirconate, SiO₂, silicate such as for example aluminium-containing silicate, mica, clay mineral, zeolite, sparingly soluble sulfate such as barium sulfate or hydrated calcium sulfate, of flakes, for example based on SiO₂ and/or silicate(s), of oxide(s) with a content of aluminium, iron, calcium, copper, magnesium, titanium, zinc, tin and/or zirconium.

Particularly fine grain particles may be produced for example via a sol and/or a gel, such as for example a silica sol. The advantage of coating a sol lies in the high mobility of the components despite high concentrations. Such particles often have a mean particle size in the range from 10 to 120 nm. On account of the fine granularity of the particles formed thereby, a particularly uniform distribution of the conductive polymers is obtained especially in the case of a thin coating with a shell.

It may possibly also occur in the preparation of such inorganic particles that the conductive polymer is in some cases largely or completely incorporated in the interior of these particles, such particles also being regarded here as “coated particles” and as core-shell particles within the meaning of the present application.

In some embodiments narrower particle size distributions than those often occurring in inorganic particles are particularly preferred. These may be obtained for example by mixing different distributions, by screening or size classification, or by grinding.

Particularly preferred are inorganic particles that are formed substantially platelet-shaped, substantially linear shaped and/or substantially needle-shaped. In this way they may also act more powerfully as barrier particles.

Inorganic particles may to some extent also be present in a stable dispersion, in particular depending on the particle size, concentration, density, electrolyte content, etc.

### Monomers/Oligomers Used for the Production of Conductive Polymer:

To form the conductive polymers it is necessary to add to the educt mixtures monomers and/or oligomers that are capable of being converted into conductive polymers. The monomers and/or oligomers are termed “educt(s)”. The monomers and/or oligomers are preferably selected from monomers and/or oligomers of inorganic and/or organic nature selected from aromatic compounds and/or unsaturated hydrocarbon compounds such as for example alkynes, heterocyclic compounds, carbocyclic compounds, their derivatives and/or their combinations that are capable of forming therefrom electrically conductive oligomers/polymers/copolymers/block copolymers/graft copolymers, and are particularly preferably selected from unsubstituted and/or substituted heterocyclic compounds where X=N and/or S.

An addition of unsubstituted and/or substituted compounds based on imidazole, naphthalene, phenanthrene, pyrrole, thiophene and/or thiophenol is particularly preferred.

In general the substitution of the monomers and/or oligomers and/or of the oligomers, polymers, copolymers, block copolymers and/or graft copolymers formed therefrom may be effected in particular by hydrogen (H), hydroxyl (OH), halogen (Br/Cl/F), alkoxy (O-alkyl), alkyl (C_{X}H_{Y}), carboxy (COH), carboxylate (COOH), amine (NH₂), amino (NH₃), amide (CONH₂), primary ammonium (NRH₃⁺), imine (NH), imide (COHNH), phosphonate (PO₃H₂), diphosphonate, mercapto (SH), sulfone (SO₂H), sulfonate (SO₃H), aryl ((C₆H₅)ₙ) and/or unbranched or branched alkyl chains with or without further substituents, in which the substituents should preferably be not too large.

For the production of the conductive polymer educt(s) is/are preferably added to the mixture, in which at least one educt has a relatively loose molecular structure and/or in which at least one of the formed conductive polymers has a relatively loose molecular structure, in particular so that this leads to a larger mean pore size (often as molecular channel size) of the pore system of the conductive polymer.

Preferably this is achieved by using at least one educt with at least one incorporated side chain, such as for example an alkyl chain of at least one C atom such as for example in the incorporation of a CH₃ group, or in particular at least 2 or at least 4 C atoms and/or at least a ring system, which is formed in particular with organic groups, such as for example by condensation of a bridge of an ether that forms a ring system.

The at least one educt system may in particular be selected from unsubstituted and/or substituted compounds based on imidazole, naphthalene, phenanthrene, pyrrole, thiophene and/or thiophenol, and of the unsubstituted educts pyrrole is particularly preferred. Most particularly preferred are unsubstituted or substituted compounds selected from monomers and/or oligomers based on bithiophenes, terthiophenes, alkylthiophenes such as e.g. methylthiophene and/or ethylthiophene, ethylene dioxythiophene, alkylpyrroles such as e.g. methylpyrrole and/or ethylpyrrole and/or polyparaphenylene. Particularly preferred are educts from which substituted dendritic and/or conductive polymers can be produced. If necessary at least one educt is also produced separately beforehand and/or in rare cases is added to the composition for the coating of metallic surfaces. Normally however at least one depot substance, which however is generally free or substantially free of educt(s), is added to this composition.

Among the substituted educts, particularly preferably at least one compound is selected from benzimidazoles, 2-alkylthiophenols, 2-alkoxythiophenols, 2,5-dialkylthiphenols, 2,5-dialkoxythiophenols, 1-alkoxypyrroles in particular with 1 to 16 C atoms, 1-alkoxypyrroles in particular with 1 to 16 C atoms, 3-alkylpyrroles in particular with 1 to 16 C atoms, 3-alkoxypyrroles in particular with 1 to 16 C atoms, 3,4-dialkylpyrroles in particular with 1 to 16 C atoms, 3,4-dialkoxypyrroles in particular with 1 to 16 C atoms, 1,3,4-trialkylpyrroles in particular with 1 to 16 C atoms, 1,3,4-trialkoxypyrroles in particular with 1 to 16 C atoms, 1-arylpyrroles, 3-arylpyrroles, 1-aryl-3-alkylpyrroles in particular with 1 to 16 C atoms, 1-aryl-3-alkoxypyrroles in particular with 1 to 16 C atoms, 1-aryl-3,4-dialkylpyrroles in particular with 1 to 16 C atoms, 1-aryl-3,4-dialkoxypyrroles in particular with 1 to 16 C atoms, 3-alkylthiophenes in particular with 1 to 16 C atoms, 3-alkoxythiophenes in particular with 1 to 16 C atoms, 3,4-dialkylthiopehenes in particular with 1 to 16 C atoms, 3,4-dialkoxythiophenes in particular with 1 to 16 C atoms, 3,4-ethylenedioxythiophenes and their derivatives. In this connection at least one compound can be selected based on pyrrole-1-ylalkylphosphonic acid in particular with 1 to 16 C atoms, pyrrole-1-ylalkylphosphonic acid in particular with 1 to 16 C atoms, pyrrole-3-ylalkylphosphonic acid in particular with 1 to 16 C atoms, pyrrole-3-ylalkylphosphonic acid in particular with 1 to 16 C atoms, 5-alkyl-3,4-ethylenedioxythiophene in particular with 1 to 12 C atoms, 5-(ω-phosphono)alkyl-3,4-ethylenedioxythiophene and their derivatives, in particular with 1 to 12 C atoms, which are produced, used as a basis for the production of the depot substance, or are added to the composition. The number of C atoms may in each case independently of one another be 1, 2, 3, 4, 5, 6, 7, 8, 9, 10, 11, 12, 13, 14, and/or 16.

Among the substituted educts, most particularly preferably at least one compound is selected from 2-methylthiophenol, 2-methoxythiophenol, 2,5-dimethylthiophenol, 2,5-dimethoxythiophenol, 1-methylpyrrole, 1-ethylpyrrole, pyrrole-1-ylalkyophosphonic acid in particular with 10 and/or 12 C atoms, pyrrole-1-ylalkylphosphate in particular with 12 C atoms, 1-methoxypyrrole, 1-ethoxypyrrole, pyrrole-3-ylalklyphosphonic acid in particular with 6, 8 and/or 11 C atoms, 3-methoxypyrrole, 3-ethoxypyrrole, 3,4-dimethylpyrrole, 3,4-dimethoxypyrrole, 1,3,4-trimethylpyrrole, 1,3,4-trimethoxypyrrole, 1-phenylpyrrole, 3-phenylpyrrole, 1-phenyl-3-methylpyrrole, 1-phenyl-3-methoxypyrrole, 1-phenyl-3,4-dimethylpyrrole, 1-phenyl-3,4-dimethoxypyrrole, 3-methylthiophene, 3-ethylthiophene, 3-hexylthiophene, 3-octylthiophene, 3-methoxythiophene, 3-ethoxythiophene, 3-hexoxythiophene, 3-octoxythiohene, 3,4-dimethylthiophene, 3,4-dimethoxythiophene, 5-(-(ω-phosphono)methyl-3,4-dioxythiophene and their derivatives, is produced, used as a basis for the production of the depot substance, or is added to the composition.

These also include the educts that may be used for the production of conductive polymers that comprise at least one coupling-promoting group in the molecule and are therefore termed “coupling agents” or “coupling agent particles”.

In particular at least one compound selected from ethylthiophene, ethylenedioxythiophene, methylthiophene, 3-ethylpyrrole, 3-methylpyrrole, N-ethylpyrrole, N-methylpyrrole, 3-phenylpyrrole and their derivatives is produced, used as a basis for the production of a depot substance, or is added to the composition. Also particularly preferred are heterocyclopentadiene (HCP), dioxy-3,4-heterocyclopentadiene (ADO-HCP), di- to octoheterocyclopentadiene (OHCP) and benzoheterocyclopentadiene (BHCP).

By means of nucleophilic attack the conductive polymers of the coated particles according to the invention or the particles containing a proportion of conductive polymer can be chemically attacked if the pH value is not suitable for them. It is therefore advantageous to use educts with at least one substituent such as for example alkoxy and/or alkyl in particular in the 3- and/or 4-position, which form conductive polymers that cannot be adversely affected by nucleophilic attack or deactivation, which can lead to a deterioration of the electrical conductivity. These may in particular be educts based on heterocyclic compounds with at least one alkyl chain and/or with at least one ring system. Furthermore, such educts are also advantageous on account of the fact that the cross-linkability is thereby advantageously restricted and because the conductive polymers formed therefrom generally have pore systems with particularly large pore channels. Most particularly preferred are compounds whose monomers and/or oligomers can at least to some extent be dissolved and/or polymerised in water. Especially advantageous are those compounds that can be polymerised at least partially or temporarily in water or solvent mixtures containing water.

Likewise, it is preferred to add to the mixture for the production of the conductive polymer at least one educt that is water-soluble and that preferably after its oxidation (=polymerisation) is no longer, or is still only slightly, water-soluble.

Monomers are used inter alia on account of the fact that they may be more economical and/or may have a higher solubility and higher diffusion coefficients. Oligomers are then used in particular if the corresponding monomer cannot be polymerised and if only the oligomer can be polymerised. Oligomers may in many cases be more reactive than monomers.

Educts in the form of copolymers and/or block copolymers may likewise already be present in the educt mixture in addition to the monomers/oligomers, whereas graft copolymers are normally first formed by further chemical reaction(s) with at least one further organic constituent, such as for example with a carboxyl and/or ester group, in particular on the polymer skeleton of the coatings.

Preferably at least one educt is added which is chemically stable in a wide pH range after its polymerisation to form conductive polymer. Preferably the oxidising agent that is used is also stable at the chosen pH value. It is preferred if this pH range includes at least 1 or 2 units, i.e. for example pH values in the range from 3 to 4.5.

The conductive polymers and possibly also the particles may in this connection have been produced in an educt mixture that had possibly contained:
optionally at least one monomer and/or at least one oligomer with a content of educt(s) in the range from 0.001 to 25 wt. % or up to 20 wt. %,
at least one mobile anti-corrosive anion and/or at least one salt, an ester and/or at least one acid as carrier of this anion, with a content of mobile anti-corrosive anions in the range from 0.05 to 50 wt. % calculated as anion(s),
optionally at least one oxidising agent with a content of oxidising agents in the range from 0.05 to 50 wt. %,
at least one type of inorganic and/or organic particles with a content of particles in the range from 1 to 95 wt. % or up to 96 wt. %,
wherein all these amounts and possibly further additives, not mentioned here, but excluding solvents, together total 100 wt. %, as well as
at least one solvent for the educts, for the anions and/or for the oxidising agents is included, with contents of solvents in the range from 1 to 5000 wt. %, specified above 100 wt. %,
   wherein the sum of the solids totals 100 wt. % if—possibly later—monomer/oligomer or oxidising agent is added.

### Conductive Polymers:

From the addition of an amount of monomers and/or oligomers (educts) which are suitable for the formation of conductive polymers, at least partially conductive polymers (=products, depot substance) are formed by the oxidation. If oxidising agent is added oxidised educts may be formed from the educts, which then polymerise and to which further groups may become attached. Relatively small oligomers, for example those where say n=8, then exhibit scarcely any or none of the properties of the conductive polymers. The conductive polymers are electrically neutral in the reduced state. In the oxidation (=polymerisation) of the conductive polymers cations are formed which can accordingly attract anions. The oxidised state may be adjusted chemically with at least one oxidising agent, electrochemically and/or photochemically. Preferably no electropolymerisation is carried out, but instead largely only chemical and/or photochemical polymerisation is performed, in particular only chemical and/or photochemical polymerisation. Particularly preferably only, or mainly only, chemical polymerisation is performed.

A depot substance may in principle be polymerised chemically, electrochemically and/or photochemically. Preferably the at least one depot substance or the composition containing it is applied chemically and/or mechanically, in particular to the particles or to the metallic surfaces. In the case of an electrochemical application the comparatively reactive metallic surfaces must be passivated beforehand in order to suppress the vigorous dissolution of the metallic substances. In the case of electrochemical application corrosion-inhibiting anions must therefore always be added to the solution from which at least one educt is polymerised, in order always to form first of all a passivation layer. The conductive polymer formed in this way then automatically contains corrosion-inhibiting anions, although the publications which describe corrosion-inhibiting anions clearly never mention a release of these anions on account of a drop in potential.

With electrochemical polymerisation the particles often have to have a negative zeta potential. The coatings that have been produced by electrochemical polymerisation on particles have proved to be of comparatively poor quality. In the case of photochemical polymerisation semiconducting particles are often necessary, which for example release defect electrons under UV irradiation. Here too the coatings that have been produced by photochemical polymerisation on particles have been found to be of relatively poor quality. In addition the polymer shell could be damaged under UV irradiation. The coatings which on comparison have proved to be best have now been produced by chemical polymerisation.

The conductive polymers have a salt-like structure, which means that in the case of anion-charged conductive polymers they can be described as salts.

The at least one polymer, copolymer, block copolymer and/or graft copolymer is hereinafter simply referred to as “polymer” or as “conductive polymer”. In the process according to the invention the at least one depot substance is preferably at least one conductive polymer, in particular at least one conductive polymer based on imidazole, naphthalene, phenanthrene, pyrrole, thiophene and/or thiophenol, especially based on pyrrole and/or thiophene. Preferably conductive polymers are formed based on polyphenylene, polyfuran, polyimidazole, polyphenanthrene, polypyrrole, polythiophene and/or polythiophenylene, or those that are at least partially or temporarily polymerised in water. The particularly preferred conductive polymers include for example those based on polypyrrole (PPy), polythiophene (PTH), poly(para-phenylene (PPP) and/or poly(para-phenylenevinylene) (PPV). The depot substance is produced either separately or in a mixture beforehand and then added to the composition and/or, in rare cases, is added as educt to the composition and/or reacts in the composition and/or in the coating to form the depot substance.

In the process according to the invention preferably at least one depot substance and at least one anion are chosen that permit a substantial or complete release of the anions from the depot substance, whereby the cation transport rate of the cations, in particular from the electrolyte and/or from the defect, can be significantly reduced, whereby in turn the formation of harmful radicals in the region of the metal/coating interface can be reduced.

Preferably the conductive polymers produced or used according to the invention are thermodynamically so stable in the oxidised (=doped) state that they cannot discharge by themselves—even over a relatively long time—and that also their anions cannot be released without reduction. These chemical systems are thus distinguished from many other depot systems which are not conductive polymers, in which the anions can leave the depot substance prematurely.

It is particularly preferred to produce and/or add to the mixture at least one polymer that is selected from compounds based on poly(1-alkylpyrrole) (P1APy) in particular with 1 to 16 C atoms, poly(1-alkoxypyrrole), (P1AOPy) in particular with 1 to 16 C atoms, poly(3-alkylpyrrole) (P3APy) in particular with 1 to 16 C atoms, poly(3-alkoxypyrrole) (P3AOPy) in particular with 1 to 16 C atoms, poly(1-arylpyrrole) (P1ArPy), poly(3-arylpyrrole) (P3ArPy), poly(3-alkylthiphene) (P3ATH) in particular with 1 to 16 C atoms, poly(3-alkoxythiophene) (P3ATH) in particular with 1 to 16 C atoms, poly(3-arylthiophene) (P3ArTH), poly(3-alkylbithiophene) in particular with 1 to 16 C atoms, poly(3,3′-dialkylbithiophene), poly(3,3′-dialkoxybithiophene), poly(alkylterthiopene), poly(alkoxyterthiophene), poly(3,4-ethylenedioxythiphene) (PEDOT) and poly(benzo[b]thiophene (PBTH).

It is particularly preferred to produce and/or to add to the mixture at least one polymer that is selected from poly(1-methylpyrrole) (P1MPy), poly(1-methoxypyrrole) (P1MOPy), poly(3-methylpyrrole) (P3 Mpy), poly(3-methoxypyrrole) (P3MOPy), poly(1-phenylpyrrole) (P1PhPy), poly(3-phenylpyrrole) (P3PhPy), poly(3-methylthiophene), poly(3-hexylthiophene), poly(3-methoxythiophene), poly(3-hexoxythiophene), poly(3-phenylthiophene), poly(3-methylbithiophene), poly(3-hexylbithiophene), poly(3,3′-dimethylbithiophene), poly(3,3′-dihexylbithiophene), poly(3,3′-dimethoxybithiphene), poly-(3,3′-dihexoxybithiophene), poly(3-methylterthiophene), poly(3-methoxyterthiophene), poly(5-alkyl-3,4-ethylenedioxythiophene) in particular with 1 to 12 C atoms, poly(isothianaphthene) (PITN), polyheterocyclopentadiene (PHCP), dioxy-3,4-heterocyclopentadiene (ADO-HCP), di- to octoheterocyclopentadiene (OCHP), poly(3-hexylthiophene) (P3HT), substituted and/or conductive poly(para-phenylene) (PPP and LPPP) and substituted and/or conductive poly(para-phenylenevinylene) (PPV and LPPV).

The particularly preferred conductive polymers include inter alia polypyrrole (PPy), poly(N-methylpyrrole) (PMPy), poly(3-alkylpyrrole) (P3AlPy), poly(3-arylpyrrole) (P3ArPy), poly(isothianaphthene) (PITN), poly(3-alkyl-thiophene) (P3AlT), poly(alkylbithiophene), poly(alkyl-terthiophene), poly(ethylenedioxythiophene) (PEDOT), poly(3-arylthiophene) (P3ArT), substituted and/or conductive poly(para-phenylenevinylene) (PPV), poly(3-hexylthiophene) (P3HT), poly(3-hexylthiophene) (P3HT), polyphenylene (PP), polyparaphenylenevinylene (PPV), polyheterocyclopentadiene (PHCP), polydioxy-3,4-heterocyclopentadiene (PADO), polybenzoheterocyclopentadiene (PBHCP), polythiophene (PT), poly(3-alkylthiophene) where R=alkyl such as for example methyl, butyl, etc. (P3AT), polypyrrole (PPy), poly(isothianaphthene) (PITN), poly(ethylenedioxythiophene) (PEDOT), alkoxy-substitited poly(para-phenylenevinylene) (MEH-PPV), poly(2,5-dialkoxy-para-phenylenvinylene) (MEH-PPV), conductive poly(para-phenylene) (LPPP), poly(para-phenylenesulfide) (PPS) as well as poly(3-hexylthiophene) (P3HT).

Among the polymers there may also be chosen poly(1,3-dialkylpyrrole), poly(3,4-dialkylpyrrole), poly(3,4-dialkylthiophene), poly(1,3,4-trialkylpyrrole), poly(3,4-dialkoxythiophene), poly(1,3,4-trialkoxypyrrole), poly(2-arylthiophene), in each case independently of one another, in particular with 1 to 16 C atoms, or corresponding educts. Among the aryl compounds there may in particular be chosen 1-phenyl, 3-phenyl, 1-biphenyl, 3-biphenyl, 1-(4-azobenzene) and/or 3-(4-azobenzene) compounds.

Preferably in this case compounds are produced or used independently of one another with alkyl chains containing 1, 2, 3, 4, 5, 6, 7, 8, 9, 10, 11, 12, 13, 14, 15 and/or 16 C atoms.

In the educts and/or polymers there may preferably be chosen as substituents in each case independently of one another H, OH, O, COOH, CH₂OH, OCH₃, CnH₂ₙ₋₁ in particular where n=2 to 12, OCₙH₂ₙ₋₁ in particular where n=2 to 12, alkyl, alkoxy, aryl, amine, amino, amide, primary ammonium, imino, imide, halogen, carboxy, carboxylate, mercapto, phosphonate, S, sulfone and/or sulfonate.

Also included are the conductive polymers that comprise at least one coupling-promoting group in the molecule and are therefore termed “coupling agents” or “coupling agent particles”.

The conductive polymers that are suitable for this purpose are in principle often known, although in most cases they are not yet described as such for at least one variant of the corrosion protection; in those cases where the corrosion protection is described for this polymer, the corrosion protection however does not function in the case of more reactive metallic surfaces without an already existing passivation layer. In individual embodiments also at least one depot substance can at least partially form a matrix in the composition, in particular in the vicinity of the metal/coating interface. The least conductive polymers are commercially obtainable.

It is advantageous to use either a conductive polymer modified by substituents and/or by another base molecule (monomer/oligomer), and/or a conductive copolymer containing at least two different base molecules (monomers/oligomers) with somewhat different redox potentials, in order to vary significantly the redox properties of the depot substance from compound to compound. Alternatively or in addition, suitably different depot substance may be mixed with one another. For this purpose at least one compound can be chosen that exhibits the correct value of the redox potential for the chemical system including the metallic surface, and/or a mixture can be prepared that contains different conducting polymers with different redox potentials. The redox potential of the depot substance is in particular suitable if it is at least 75 mV, at least 100 mV or at least 150 mV, preferably at least 200 mV or at least 250 mV, most particularly preferably at least 300 mV or at least 350 mV above the corrosion potential of the metallic surface.

Preferably the mean pore size of the conductive oligomer, polymer, copolymer, block copolymer and/or graft copolymer to be formed is increased by adjusting a higher temperature in the formation of the coating and/or when drying the mixture, in particular a temperature in the range from 60 to 200° C. in an inert atmosphere, and in particular in the range from 30° to 80° C. in air.

Solvents of the Educt and/or Product Mixture:

Water may in many embodiments be used as the sole solvent in the mixture for the production of the conductive polymer. It is advantageous to use water as one of the solvents in a solvent mixture, the water content of the solvent mixture then accounting for at least 5 wt. %. The process can in this way be carried out in a simpler and more environmentally friendly manner and the majority of the anions can be brought into solution. Preferably a larger proportion of water is used in the solvent mixture or indeed only water is used as solvent, especially as many anions are soluble only in water, and are often not soluble in organic solvents or in many organic solvents.

Preferably only, or substantially only, water is added as solvent, or in the case of a solvent mixture there is added as the at least one further solvent at least one solvent that is liquid in the temperature range from −30° to 200° C., particularly preferably in the range from −10° to 160° C., or most particularly preferably in the range from 1° to 95° C. In this connection the solvents may optionally act substantially selectively and dissolve mainly or only the educts or mainly or only the anions and oxidising agent. Also, it is advantageous if the solvents can react chemically only slightly or indeed not at all with the oxidising agent, even at elevated temperature. The solvents normally do not dissolve, or dissolve only slightly the formed oligomers, polymers, copolymers and/or graft copolymers of the conductive polymers.

Preferably in a solvent mixture, in particular apart from water at least one solvent selected from more or less polar, dipolar aprotic and dipolar protic liquids is added as the at least one further solvent. The plurality and thus the dielectric constant may in this connection be varied within wide ranges. Weakly polar liquids such as chloroform and/or dichloromethane or dipolar aprotic liquids such as acetonitrile and/or propylene carbonate are used in particular for those educts in which the process cannot be carried out with water—in particular for compounds for example based on thiophenes. Polar protic liquids such as water and/or alcohols are generally used for the oxidising agents and anions. Solvents of lesser plurality, such as for example alcohols, are preferably used to dissolve the educts, while solvents of high plurality, such as for example water, are preferably used to dissolve the oxidising agents and salts as well as to dilute the acids.

Preferably in a solvent mixture at least one solvent selected from acetonitrile, chloroform, dichloromethane, ethanol, isopropanol, methanol, propanol, propylene carbonate and water is added as the at least one further solvent. Often solvent mixtures of water with at least one alcohol are used, which optionally may also contain at least one further solvent and/or also at least one further liquid which, such as for example an oil, is not a solvent.

It is also particularly advantageous to use a solvent mixture consisting of water and at least one organic solvent, since for example molybdate is sufficiently soluble at the necessary concentration virtually only in water and since some pyrrole derivatives are normally sufficiently soluble at the necessary concentration only with at least a minor addition of at least one water-miscible organic solvent, the content of the at least one organic solvent in the solvent mixture being in particular at least 2 wt. %, preferably at least 6 wt. %, particularly preferably at least 12 wt. %, most particularly preferably at least 18 wt. % and especially even at least 24 wt. %. The degree of conversion of the educts to the conductive polymers is often of the order of magnitude of 85 to 99%, generally in the range from 88 to 96%.

### Product Mixture:

The product mixture in which conductive polymer is being formed and/or is formed, contains the same or substantially the same amounts of constituents as the educt mixture if one disregards chemical reactions. The same quantitative amounts/details therefore apply as appropriate.

At least one stabiliser that has optionally been used in the previously employed emulsion polymerisation may also be added, or has already been added, to the product mixture. Preferably the at least one stabiliser is also at least one ionic or non-ionic stabiliser—in particular at least one polymerisable and/or polymerised surfactant that optionally exhibits emulsifier properties. Particularly preferably the stabiliser is selected from water-soluble polymers based on polyvinyl alcohol, polyvinyl alkyl ethers, polystyrene sulfonate, polyethylene oxide, polyalkyl sulfonate, polyaryl sulfonate, anionic and/or cationic surfactants, quaternary ammonium salts and tertiary amines. Most particularly preferably they are selected from the group comprising anionic and/or cationic surfactants of the alkyl sulfates and alkyl sulfonates of preferably sodium, in particular with an alkyl chain length in the range from 10 to 18 C atoms. These water-soluble polymers and surfactants are advantageous in order to disperse the particles more effectively.

The product mixture may optionally contain substantially no stabiliser or preferably 0.01 to 5 wt. % of at least one stabiliser for the anionic, cationic, steric and/or neutral stabilisation of the particles in the educt mixture and in the product mixture formed therefrom, particularly preferably 0.5 to 4 wt. % or 0.05 to 3 wt. %, and most particularly preferably 0.1 to 2 wt. %.

### Treatment of the Particles Containing Conductive Polymer:

Preferably the product mixture with coated particles is dried by decanting, filtration and/or freeze-drying, in particular by spin-drying or centrifugation with filtration, and/or by gas circulation and/or added heat, in particular at temperatures of up to 200° C. in an inert atmosphere or preferably at temperatures of up to 150° C. or up to 120° C. This is normally necessary with coated inorganic particles. In this way the liquid-containing mixture is largely or thoroughly dried. Where the coated inorganic particles have largely been separated from liquids, for example by decanting, filtration and/or drying, the content of solvents is often in the range of about 1, 2, 3, 4, 5 wt. %, or often only with contents of up to 10 wt. %. The dried “mixture” is hereinafter referred to as “conductive powder”. In this form the coating on the particles is stable, is permanently electrically conducting, and is also permanently chemically and also physically resistant as long as no nucleophilic attack takes place, for example if used in an unsuitable paint system, under excessive thermal stress, such as for example above 300° C., or due to photochemical decomposition, for example in the presence of photoactive particles such as e.g. TiO₂ (anatase) and/or when subjected to severe weathering conditions. The coating formed in this case is often particularly adherent and/or is largely or completely sealed.

Preferably the total amount of liquid(s) is not removed in the drying, and instead it is advantageous if for example a liquid content remains in the range from 0.1 to 12 wt. % referred to the content of in particular inorganic uncoated particles in the powder bed. This is advantageous since the pores then (still) cannot become smaller as a result of the reverse swelling of the conductive polymer.

If necessary the coated inorganic particles may be briefly ground and/or slightly ground in order to break up and/or render flowable so-called cakes, agglomerates and/or possibly also aggregates. The conductive powders are optionally also graded by size.

Preferably the coated inorganic particles are first of all decanted, filtered and/or dried. Following this an extraction of the extractable constituents from the conductive coating can be carried out in such a way that substantially no incorporated anions and substantially no oxidising agent required for the conductive polymer for the purposes of stabilisation are extracted. In this way the conductive stable structure of the conductive polymers and their conductivity state are left substantially unaltered. Excess oxidising agent that could react for example with a paint, non-incorporated anions, unreacted monomers and oligomers, and other impurities as well as other non-essential constituents can be removed in the extraction. The extraction may in particular be carried out with an acidic aqueous solution, such as for example with sulphuric acid, hydrochloric acid and/or with at least one organic solvent such as for example acetonitrile, chloroform and/or methanol. This step can significantly improve the quality of the coating.

It has been found that, after the production of the core-shell particles, sometimes a stabiliser can advantageously be added, although often it is not necessary. The addition of a stabiliser to an already stable product mixture is in some embodiments even disadvantageous however. On the other hand an unstable product mixture, for example if the concentrations, in particular of conductive polymer have been chosen to be too high, can be stabilised by addition of a stabiliser.

### Particles Containing Conductive Polymer

In principle many details that refer specifically to the particles containing conductive polymer with inorganic and/or organic particles can in many cases also be extrapolated to other of the six types of particles containing conductive polymer.

In the case of inorganic and/or organic particles that are coated with conductive polymer, the conductive polymer is preferably present substantially in the oxidised, electrically conducting state, in which connection at least an increased content of mobile anti-corrosive anions and possibly also a content of coupling anions are incorporated in the conductive polymer.

The contents of the constituents in the conductive coating of the particles may vary within wide limits. The variation depends in particular on the thickness of the coating: ultra-thin, thin, thick or very thick coatings may be applied, which have a layer thickness in the range from 0.1 to 10 nm, from >10 to 100 nm, from >100 nm to 1 μm or from >1 μm to 20 μm. Constituents of low or high density may also be selected. In addition the specific surface of the inorganic particles may also contract sharply, such as for example in the case of SiO₂ powders that have been produced by flame hydrolysis.

Preferably the content of conductive polymers in the conductive coating of the particles is for example 50, 52, 54, 56, 58, 60, 62, 64, 66, 68, 70, 72, 74, 76, 78, 80, 82, 84, 86, 88, 90, 92, 94, 96, 98 or 100 wt. % referred to the coating. In particular the content of conductive polymers in the conductive coating of the particles is in the range from 48 to 100 wt. %, particularly preferably in the range from 61 to 97 wt. %, and most particularly preferably in the range from 69 to 95 wt. %.

Preferably the content of anions is for example 10, 12, 14, 16, 18, 20, 22, 24, 26, 28, 30 or 32 mole % referred to the conductive polymer of the coating. Preferably the content of oxidising agents referred to the coating is 0% and as far as possible not greater than 0%. In particular the content of anions in the conductive coating is in the range from 8 to 35 mole %, particularly preferably in the range from 15 to 33 mole %, and often in the range from 19 to 32 mole %.

Preferably the content of particles in the content of particles including their coatings and inclusions based on conductive polymer is for example 6, 8, 10, 12, 14, 16, 18, 20, 22, 24, 26, 28, 30, 32, 34, 36, 38, 40, 42, 44, 46, 48, 50, 52, 54, 56, 58, 60, 62, 64, 66, 68, 70, 72, 74, 76, 78, 80, 82, 84, 86, 88, 90, 92, 94, 96 and 98 wt. %. In particular the content of particles including their coatings and inclusions based on conductive polymer in the binder-rich conductive coating is in the range from 5 to 100 wt. %, particularly preferably in the range from 55 to 99 wt. %, most particularly preferably in the range from 75 to 98 wt. %, and above all in the range from 85 to 97 wt. %.

Preferably the mean pore size of the conductive polymer to be formed is enlarged by increasing the swelling of the electrically conducting polymer to be formed, by adding a readily vaporisable organic liquid such as for example chloroform in the case of polythiophene, or such as for example alcohol in the case of polypyrrole and many polypyrrole derivatives.

Despite their small thickness, the coatings on the particles are often highly coloured. In many cases the coatings are pale green to dark green, pale blue to dark blue, pale grey to dark grey, pale red to dark red, violet, brown or black. The conductive polymers are often hydrophobic, although they may be rendered more hydrophilic or hydrophobic depending on the anion content, oxidation state, pH value and substitution of the side groups.

The electrical conductivity of the coating on particles that have been coated with a coating containing conductive polymer may, depending on the degree of oxidation, on the nature of the charge carriers and/or on the charge carrier mobility, be in the range from 10⁻⁸ to 10⁰ S/cm, preferably in the range from 10⁻⁶ to 10⁻¹ S/cm, and particularly preferably in the range from 10⁻⁵ to 10⁻² S/cm.

The degree of doping may be determined by elementary analysis or by X-ray spectroscopy. It is normally in the range from 5 to 33%, a degree of doping higher than 28% being achieved only in some cases in practice. Degrees of doping in the range from 20% to 33% are often achieved.

The quality of the conductive coating may in principle be increased by adjusting the maximum possible degree of doping of the conductive polymers with mobile anti-corrosive anions, which leads to a high depot effect and often also to a sufficient electrical conductivity of the coating to be formed. A sufficient electrical conductivity is satisfactory in many applications, since too high an electrical conductivity may possibly cause the potential gradient to break down rapidly and in certain circumstances may cause the driving force for the anion migration to drop quickly or stop (short-circuit effect) before the anions can exert their anti-corrosive action.

The conductive polymer-containing coating on the particles should preferably contain no oxidising agent or virtually no oxidising agent, since this may damage the anti-corrosive action of the organic coating containing coated particles. It is therefore recommended to remove excess oxidising agent and/or other possibly interfering substances from the product mixture or from the particles containing conductive polymer that are stored in the dry or moist state or as a dispersion, for example by dialysis, extraction and/or filtration.

The layer thickness of the layer of the conductive polymer on the particles may be varied within wide ranges. Preferably the layer thicknesses are in the range from 1 to 200 nm, particularly preferably in the range from 2 to 100 nm and especially in the range from 3 to 80 nm. These layers are, depending on the circumstances, thinner in organic particles than in organic particles. Although thicker layers are in principle conceivable and possible, they could however be subject to limits if the coated particles can no longer be dispersed.

### Production and Addition of So-Called “Coupling Agent Particles” of Conductive Polymer

Also at least one so-called “coupling agent” based on conductive polymer, and which can be produced in particular by emulsion polymerisation, may be added to the binder-rich mixture. This is at least one depot substance with in each case at least one substituent per molecule, which improves the adhesion to the metallic surface. In particular, in this way the adhesion at the metal/binder matrix interface and the anti-corrosion effect can both be improved. Since the “bonding agent” also always contains at least one mobile anti-corrosive anion, in the case of a potential gradient as a result of damage to the coating a rapid short migration of such anions to the damaged region is possible, since the “coupling agents” after the application of the binder-rich and still water-containing coating to the metallic surface preferentially diffuse to the interface between the metal and binder matrix and are thus adsorbed particularly close to the interface (near-interface depot). The “coupling agents” can therefore accumulate to a greater extent near the interface, whereas the conductively coated particles are for the most part distributed more or less uniformly over the layer thickness of the coating.

The at least one “coupling agent” may be produced in the targeted copolymerisation of monomer(s)/oligomer(s) with coupling group-substituted monomer/oligomer building blocks that are synthesised from the same monomer(s)/oligomer(s). The monomer(s)/oligomer(s) may be selected from those based on benzene, furan, imidazole, naphthalene, phenanthrene, phenol, pyrrole, thiophene and/or thiophenol. The substituents may be selected from alkanoic acids, such as for example carboxylic acids, from phosphonic acids, phosphoric acids, sulfonic acids and their salts with at least one unbranched alkyl chain containing, independently of one another, in each case at least 6 to 20 C atoms, in which connection possibly also at least one double chain may be formed. Particularly preferred are substituted monomers and/or substituted oligomers based on benzene, bipyrrole, furan, imidazole, naphthalene, phenanthrene, phenol, pyrrole, thiophene and/or thiophenol with at least one substitution, independently of one another, by at least one phosphonic acid.

The “coupling agent” may be produced separately from the process for the preparation and coating of particles, by emulsion polymerisation in an optionally particle-free mixture that generally contains a water-alcohol mixture, at least one oxidising agent—preferably oxidising agent with at least one mobile anti-corrosive anion acting as an oxidising agent, at least partially instead of the separate oxidising agent, at least one mobile anti-corrosive anion, at least one monomer/oligomer, and at least one monomer/oligomer substituted with coupling groups and which is synthesised from the same monomer(s)/oligomer(s). The emulsion polymerisation preferably takes place at room temperature or at a slightly higher temperature, and at a pH preferably in the range from 2 to 4. Substantially spherical-shaped particles, whose size can generally be adjusted and which consist largely or wholly of doped conductive polymer, are thereby formed. These particles are normally readily dispersible. The dispersions produced with these particles are as a rule stable, so that they do not have to be stirred/shaken and the particles also do not have to be redispersed.

These “coupling agent” particles may be incorporated into the binder-containing matrix in addition or alternatively to the coated inorganic and/or organic particles. The added amount of the “coupling agent” particles may be varied within wide limits, and for example they may preferably be added in amounts of 0.01 to 20 wt. %, referred to solids contents, of the binder-rich composition, particularly preferably in amounts of 0.1 to 10 wt. % and most particularly preferably in amounts of 1 to 5 wt. %.

Production of a Binder-Rich Coating with Conductively Coated Particles and Properties of this Coating

Preferably the composition according to the invention containing a binder system basically optionally includes a binder-rich system (=binder system) based on organic polymer, in addition to the particles containing conductive polymer and in addition to water and/or at least one other solvent.

The chemical composition of the binder system that is used for the preparation of the binder-rich composition may be varied within wide limits. The usable binders may in principle have widely varying compositions. In addition, the characterisation of the binder system for the special use of the coating according to the invention may also vary widely, so that in particular primers, paints, paint-like organic compositions and adhesive mixtures are possible.

The binder systems may in principle be crosslinkable or non-crosslinkable systems. In this connection the widely different types of crosslinking may be utilised individually or in combination and/or repeatedly, though procedures not involving crosslinking may also be used.

The coatings thereby obtained also comprise a binder system that is correspondingly similar to the binder system of the starting composition, though it often has a more strongly crosslinked composition compared to the starting composition. The organic coatings may after the application to the metallic surface be homogenously produced by film forming and/or polymerised by chemical curing, chemical and/or chemical-thermal curing and/or by free-radical crosslinking.

In many embodiment variants a binder system is selected that is or becomes anionically or cationically stabilised or is or becomes stabilised with in each case at least one emulsifier and/or protective colloid, and which optionally can also form films. It is particularly preferred to choose as binder system one in which at least one organic polymer that is contained in the composition forms films when the composition is dried. In some embodiment variants a binder system is chosen that can be or is chemically, chemically-thermally and/or free-radically crosslinked via at least one thermal crosslinking agent and/or via at least one photoinitiator.

For some applications it may be important that the conductive polymers that are formed are compatible with the constituents of for example a binder-rich system (=binder system), such as for example a paint system, and are not adversely affected for example by the pH of the binder system when the particles are incorporated into a binder system. In some embodiments it may be advantageous to choose chemical conditions of a buffer system that can help to prevent an overoxidation of the conductive polymer.

Cationically stabilised binder systems frequently have a pH value in the range from 1 to 7, often in the range from 2 to 6, and in many cases in the range from 3.5 to 4.5. Anionically stabilised binder systems frequently have a pH value in the range from 6 to 11, often in the range from 7 to 11 and in many cases in the range from 7.5 to 8.5. In addition there are a number of binder systems that are sterically (non-ionically) stabilised and accordingly can often be used in the acidic as well as in the alkaline range, in many cases in the pH value range from 1 to 11, though they often also contain at least one emulsifier and/or at least one protective colloid.

In some embodiment variants it appears advantageous to employ an anionically stabilised binder system that is not completely neutralised, for example by an insufficient addition of neutralising agents. In this way a marked swelling of the organic polymers and a sharp rise in the viscosity of the composition can in many cases be reduced or avoided. A better and finer distribution of the components in the resultant coating can in this way often also be achieved. In addition it is in some cases also possible to use the composition according to the invention in higher concentrations than in other types of film forming.

Preferably the binder system consists mainly, substantially or wholly of binders that are synthetic resins. Apart from the synthetic resins the binder system may also optionally contain minor amounts of monomers, plasticisers, for example based on adipin, citrate or phthalate, chemical and/or chemical-thermal curing agents and/or photoinitiators. The content of binders (=binder system), in particular largely or wholly consisting of synthetic resins, including optionally also added monomers, chemical and/or chemical-thermal curing agents, photoinitiators and/or plasticisers, in the binder-rich coating, which are not derived from or do not belong to the coated organic particles, is preferably in the range from 40 to 99 wt. % or from 50 to 98 wt. %, particularly preferably in the range from 55 to 92 wt. % and most particularly preferably in the range from 60 to 90 wt. %. The term “synthetic resins” includes in this connection monomers, oligomers, polymers, copolymers, block copolymers, graft copolymers and their mixtures, in which monomers as a rule are added only to the chemically or chemically-thermally and/or free-radically crosslinking binder system. In many cases substantially only organic oligomers, organic polymers and/or organic copolymers are added as binder to the composition containing a binder system.

The binder system preferably contains at least one synthetic resin, such as at least one organic oligomer, at least one organic polymer, at least one organic copolymer and/or their mixtures, in particular at least one synthetic resin based on acrylate, ethylene, ionomer, polyester, polyurethane, silicone polyester, epoxide, phenol, styrene, melamine-formaldehyde, urea-formaldehyde and/or vinyl. The binder system may preferably be substantially a synthetic resin mixture comprising at least one polymer and/or at least one copolymer, which in each case contains independently of one another a content of synthetic resins based on acrylate, epoxide, ethylene, urea-formaldehyde, ionomer, phenol, polyester, polyurethane, styrene, styrene/butadiene and/or vinyl. In this connection it may inter alia also involve in each case at least one cationically, anionically and/or sterically stabilised synthetic resin and/or its dispersion and/or even its solution or emulsion. The term acrylate in the context of the present application includes acrylic acid esters, polyacrylic acid, methacrylic acid, methacrylic acid esters, methacrylate and their further derivatives. Some or all binders may optionally also contain at least one silyl group and/or may also by silylated by addition of silane/siloxane/polysiloxane to the composition.

The binder system may preferably contain in each case at least one component based on
acrylate-polyester-polyurethane copolymer,
acrylate-polyester-polyurethane-styrene copolymer,
acrylic acid esters,
acrylic acid esters-methacrylic acid esters, optionally with free acids and/or
acrylonitrile,
ethylene-acrylate mixture,
ethylene-acrylate copolymer,
ethylene-acrylate-polyester copolymer,
ethylene-acrylate-polyurethane copolymer,
ethylene-acrylate-polyester-polyurethane copolymer,
ethylene-acrylate-polyester-polyurethane-styrene copolymer,
ethylene-acrylate-styrene copolymer,
polyester resins with free carboxyl groups combined with melamine-formaldehyde resins,
a synthetic resin mixture and/or copolymer based on acrylate and styrene,
a synthetic resin mixture and/or copolymer based on styrene-butadiene,
a synthetic resin mixture and/or copolymer of acrylate and epoxide,
based on an acrylate-modified carboxyl group-containing polyester together with melamine-formaldehyde and ethylene-acrylate copolymer,
polycarbonate-polyurethane,
polyester-polyurethane,
styrene,
styrene-vinyl acetate,
vinyl acetate,
vinyl ester and/or
vinyl ether.

The binder system may however also preferably contain as synthetic resin(s), a content of organic polymer, organic copolymer and/or their mixtures based on carbodiimine, polyethyleneimine, polyvinyl alcohol, polyvinyl phenol, polyvinylpyrrolidone and/or polyaspartic acid, in particular also their copolymers with a phosphorus-containing vinyl compound.

It is most particularly preferred to include also a content of synthetic resin based on acrylate, methacrylate, ionomer and/or ethylene-acrylic acid, in particular with a melting point in the range from 60° to 95° C. or with a melting point in the range from 20° to 160° C., above all in the range from 60° to 120° C.

Preferably at least 30 wt. % of the added binder system may consist of film-formable thermoplastic synthetic resins, particularly preferably at least 50 wt. %, most particularly preferably at least 70 wt. % and especially at least 90 wt. % or at least 95 wt. %. In addition the composition may also contains amounts, depending on the circumstances residual amounts, of in each case at least one monomer, oligomer, emulsifier, further types of additives, in particular for stabilising the dispersion of the binder system and/or of the conductive polymer-containing particles, curing agents, photoinitiators and/or cationically polymerisable substance. The content of monomer, oligomer, emulsifier and further additives for dispersions is—without film-forming auxiliary agents—in most cases less than 8 wt. % or less than 5 wt. %, often less than 2 wt. %, and possibly less than 1 wt. %. The composition of curing agents and accordingly in this case optionally also added crosslinkable substances as well as the corresponding measures for this, are in principle known.

Preferably the molecular weights of the added synthetic resins are in the region of at least 1000, particularly preferably in the region of at least 5000 and most particularly preferably from 20,000 to 200,000. Preferably the individual thermoplastic components of the binder system that are added to or are contained in the composition have molecular weights in the range from 20,000 to 200,000, in particular in the range from 50,000 to 150,000.

Preferably the binder system may consist of at least 40 wt. % of high molecular weight polymers, more preferably of at least 55 wt. %, most particularly preferably of at least 70 wt. %, especially of at least 85 wt. %, and in particular of at least 95 wt. %, referred to solids contents. In particular, if at least 85 wt. % of the binder system consists of high molecular weight polymers, then it is often not necessary to add curing agents such as isocyanates, or photoinitiators such as benzophenones for the chemical, chemical-thermal or free-radical crosslinking, as well as correspondingly crosslinkable synthetic resins, for the coating according to the invention to have good properties. In this case a closed, strong, high-grade film can often be successfully obtained by film forming without having to carry out a crosslinking.

The binder system preferably contains at least a proportion of at least one polymer and/or at least one copolymer with an acid number in the range from 2 to 200, often in the range from 3 to 120, and in some cases in the range from 4 to 60.

The binder system preferably contains at least a proportion of at least one polymer and/or at least one copolymer with a minimum film forming temperature (MFT) in the range from −10° to +99° C., particularly preferably in the range from 0° to 90° C., especially above 5° C.; it is most particularly advantageous if the organic film-forming agent contains at least two particularly thermoplastic polymers and/or copolymers at least in the initial stage—since the thermoplastic constituents can at least in part lose or suffer a deterioration of their thermoplastic properties in the further treatment and reaction—which, provided that a minimum film-forming temperature can be specified, have a minimum film-forming temperature in the range from 5° to 95° C., in particular of at least 10° C., wherein at least one of these polymers and/or copolymers has compared to at least a second of these polymers and/or copolymers, A) a minimum film-forming temperature that differs by at least 20° C. from that of the other component, B) has a glass transition temperature that differs by at least 20° C. from that of the other component, and/or C) has a melting point that differs by at least 20° C. from that of the other components. Preferably one of these at least two components has a film-forming temperature in the range from 10° to 40° C. and the other has a film-forming temperature in the range from 45° to 85° C. The addition of long-chain alcohols and their derivatives as film-forming agents may in this connection help to reduce temporarily the minimum film-forming temperature and possibly also to some extent to equalise the temperatures. After the application of the composition to the metallic surface the film-forming auxiliary agents may—especially during the drying—escape and then leave behind a coating having a film-forming temperature that is higher than it initially was during the drying. Preferably the film-forming temperature of the organic film-forming agents starting from the addition of film-forming auxiliary substance(s) up to the drying is in the range from 0° to 40° C., often in the range from 5° to 25° C. Homogeneous films are produced only if the film-forming temperature is exceeded during the drying and film-forming. These dried coatings are then not too soft and not too tacky, since the minimum film-forming temperature of the subsequently present synthetic resins is again roughly as high as originally, without the addition of film-forming auxiliary substances. Often the glass transition temperatures and the melting points of these binders are roughly in the region of the film-forming temperature, i.e. mostly in the range from 0° to 110° C.

In another preferred embodiment a mixture of organic binders may be used, in which at least a proportion of the binders have a glass transition temperature T_{g} that is substantially equal and/or similar to T_{g}. It is particularly preferred in this connection if at least a proportion of the binders has a glass transition temperature T_{g} in the range from 10° to 70° C., most particularly preferably in the range from 15° to 65° C. and especially in the range from 20° to 60° C. The binder system then preferably contains at least a proportion of at least one polymer and/or at least one copolymer with a minimum film-forming temperature MFT in the range from −10° to +99° C., particularly preferably in the range from 0° to 90° C. and especially from 5° C. or from 10° C. In this connection it is particularly preferred if at least two, not to say even all, constituents of the binder system have a minimum film-forming temperature in one of these temperature ranges—so long as a minimum film-forming temperature can be specified.

It is particularly advantageous if the binder system forms a film during the drying. It is particularly preferred if binders that exhibit at least 80 wt. %, in particular at least 90 wt. % of thermoplastic properties, are added to the composition.

The contents of binder system and/or synthetic resins frequently lie, referred to the solids content of the composition containing a binder system, in the range from 10 to 95 wt. % or from 20 to 92 wt. %, particularly preferably in the range from 30 to 90 wt. %, especially for example 35, 40, 45, 50, 55, 60, 63, 66, 69, 72, 75, 78, 81, 84 or 87 wt. %.

In addition the composition may in particular contain contents of additives, such as for example biocides, chelates, antifoaming agents, film-forming auxiliary substances such as for example long-chain alcohols, emulsifiers, lubricants, coupling agents, for example based on silanes or polysiloxanes, complex-forming agents, inorganic and/or organic corrosion inhibitors, wetting agents such as for example surfactants, pigments such as for example anti-corrosive pigments, acid traps, protective colloids, heavy metal compounds as basic crosslinking agents, silanes/siloxanes/polysiloxanes for example for the silylation of the organic compounds, stabilisers for example for the synthetic resins, for the components of the binder system and/or for the particles containing conductive polymer, and/or waxes such as for example polyethylene waxes, compounds based on Al, Ce, La, Mn, Se, Mo, Ti, W, Y, Zn and Zr—preferably those having anti-corrosive properties, plasticisers, as well as solvents and corresponding reaction products. In particular at least one additive is added to the composition according to the invention, selected from the group consisting of biocides, chelates, emulsifiers, antifoaming agents, film-forming auxiliary substances, lubricants, coupling agents, complex-forming agents, inorganic and/or organic corrosion inhibitors, wetting agents, pigments, acid traps, protective colloids, silanes/siloxanes/polysiloxanes, stabilisers, surfactants, crosslinking agents, plasticisers, aluminium compounds, cerium compounds, lanthanum compounds, manganese compounds, rare earth compounds, molybdenum compounds, titanium compounds, tungsten compounds, yttrium compounds, zinc compounds and zirconium compounds. The sum of all the additives, excluding the film-forming auxiliary substances, in the composition is often substantially 0 wt. % or 0.05 to 10 wt. %, frequently 0.1 to 6 wt. %, sometimes 0.15 to 4 wt. % and in some cases 0.2 to 2 wt. %.

In this connection the protective colloid may if necessary be a polyvinyl alcohol, the acid trap may be ammonia or an acetate, and the complex-forming agent may be ammonia, citric acid, EDTA or lactic acid; the stabiliser may be chosen from water-soluble polymers based on polyvinyl alcohol, polyvinyl alkyl ether, polystyrene sulfonate, polyethylene oxide, polyalkyl sulfonate, polyaryl sulfonate, anionic and/or cationic surfactants, quaternary ammonium salts and tertiary amines.

Preferably conductive polymer-containing particles are added to the composition—in particular in a particle mixture or also added separately—in which at least two types of particles are used that have significantly different particle size distributions and/or in which at least two differently produced types of particles are employed. The types of particles may be significantly different particles of only one of the six types of such particles, or may be chosen from at least two of the types 1.) to 6.).

Before the addition of the conductive polymer-containing particles, in particular before the addition of the coated inorganic particles, in some embodiments these must be redispersed by movement, such as for example by prolonged stirring and/or by application of shear forces such as for example in grinding, before addition to a liquid or a composition, in order to distribute them homogeneously or to maintain them homogenously distributed. In this connection these and possibly also further particles should be thoroughly wetted with the liquid, and if necessary also substantially converted into their individual particles (primary particles) and homogeneously distributed.

Conductive polymers: In the binder-rich composition according to the invention the concentration of the conductive polymer-containing particles may be varied within wide ranges, preferably in the range from 0.1 to 40 wt. %, particularly preferably in the range from 0.5 to 30 wt. %, and especially in the range from 1 to 20, from 2 to 15 or from 3 to 10 wt. %.

In some embodiment variants the content of conductive polymers in the coating for protecting metallic surfaces is however at values of for example, 0.5, 1, 1.5, 2, 2.5, 3, 3.5, 4, 4.5, 5, 5.5 6, 7 or 8 wt. %. In particular the content of conductive polymers in this conductive coating is frequently in the range from 0.3 to 10 wt. %, particularly preferably in the range from 0.6 to 8 wt. %, most particularly preferably in the range from 0.9 to 6 wt. %, and especially in the range from 1.2 to 4 wt. %.

Preferably the content of conductive polymer-containing particles, excluding the content of conductive polymer and/or including the content of conductive polymer in the binder-rich coating, is at values of for example 1, 2, 3, 4, 5, 6, 7, 8, 9, 10, 12, 14, 16, 18, 20, 22, 24, 26, 28, 30, 32, 34, 36 and 38 wt. %. In particular the content of particles including their contents of conductive polymer or only of particle cores in the coating of the metallic surface is in the range from 0.8 to 40 wt. %, particularly preferably in the range from 1.4 to 33 wt. %, most particularly preferably in the range from 2 to 25 wt. %, and especially in the range from 2.5 to 18 wt. %.

In many embodiment variations the conductive polymer-containing particles may be incorporated in a simple way into the composition. Preferably care is taken to ensure that no or virtually no agglomeration and coagulation occurs in the formed dispersion. This may occur in particular at high concentrations and with relatively strongly ionic components.

The chemical systems often have to be correspondingly matched to the pH value. In the case of acidic binder systems in some cases it is preferable to use conductive polymers based on polypyrrole, while in the case of alkaline systems in some cases it is preferable to use those based on polythiophene.

If the depot substance(s) is/are not compatible with binder(s), in particular at a pH value that is too high for the depot substance(s), this may result in a deactivation (“overoxidation”) of the depot substance(s). In the deactivation the conductive polymer for example loses its electrical conductivity, with the result that the incorporated anions can no longer be released. Care should therefore be taken to adjust a pH value that is compatible for all components of the coating, and to select the components of the composition accordingly.

The percolation threshold is the limiting value from which an electrically conductive pathway is established. The establishment of a conduction pathway may lead to the continuous contacting of a plurality of conductive and/or conductively coated particles. Especially in the case of a comparatively thin shell of conductive polymer on particles, but also more generally, a proportion by volume of the resultant coating or a proportion by weight of the solids of the composition or of the coating, in each case preferably in the range from 10 to 90% or from 15 to 85%, may be necessary or beneficial in order to establish or have in place a sufficient number of conduction pathways. A percentage figure in the range from 20 to 78% or from 25 to 70% is particularly preferred, a percentage in the range from 30 to 60% being most particularly preferred. These particularly preferred ranges may however also be significantly shifted if substantially smaller or larger particles are used.

It is particularly preferred to use conductive polymer-containing particles with a mean particle size in the range from 50 to 1500 nm, most particularly preferably in the range from 100 to 1000 nm. A better and more uniform distribution of the conductive polymer in the composition and in the coating can be achieved by using conductive polymers as shell material on particles. The nature of the distribution can be controlled in particular by the particle size distribution and the thickness distribution of the shells. An electrochemical treatment, such as for example a prior passivation with oxalate, is as a rule not used. Preferably the at least one layer that is intended to or can serve for the pre-treatment and passivation of the metallic surface is not passivated with the same anions that are also incorporated in the conductive polymer.

Particularly preferably the conductive polymers contain mobile anti-corrosive anions, which for a metallic surface to be protected and which is coated with an organic coating in which conductive polymer-containing particles are distributed, for example in the form of powder, additionally permit a delamination-inhibiting and/or coupling action on the said metallic surface.

In the introduction of conductive polymer-containing particles it appears to be particularly useful to utilise the advantages of the film-forming of organic particles, since in this way often more homogeneous and virtually or completely compacted films can be produced during the drying, and thus often more effectively sealed films than are obtained without film-forming. It is particularly preferred if conductively coated organic particles are used in this binder-rich coating so that also the cores of the organic coated particles at least in part undergo film-forming. In order to optimise the film-forming it should be ensured that as far as possible many or all organic polymeric constituents of the binder-rich coating, including the organic cores, have a similar or mutually matched or purposefully graded glass transition temperature T_{g} and/or minimum film-forming temperature MFT in order to permit an as comprehensive and homogeneous a film-forming as possible. If the glass transition temperature T_{g} and/or the minimum film-forming temperature MFT of the various film-formable organic components are in this connection not sufficiently close to one another and/or should be reduced further, then preferably at least one film-forming auxiliary substance, such as for example a long-chain alcohol and/or its derivatives, is added, in particular those alcohols and/or their derivatives with 4 to 20 C atoms such as a butanediol, an ethylene glycol ether such as ethylene glycol monobutyl ether, ethylene glycol monoethyl ether, ethylene glycol monomethyl ether, ethylene glycol propyl ether, ethylene glycol hexyl ether, diethylene glycol methyl ether, diethylene glycol ethyl ether, diethylene glycol butyl ether, diethylene glycol hexyl ether or a polypropylene glycol ether such as polypropylene glycol monomethyl ether, dipropylene glycol monomethyl ether, tripropylene glycol monomethyl ether, propylene glycol monobutyl ether, dipropylene glycol monobutyl ether, tripropylene glycol monobutyl ether, propylene glycol monopropyl ether, dipropylene glycol monopropyl ether, tripropylene glycol monopropyl ether, propylene glycol phenyl ether, trimethyl pentanediol diisobutyrate and/or a polytetrahydrofuran.

The minimum film-forming temperature MFT can be lowered by the addition of at least one film-forming auxiliary substance. In this way a temporary reduction of these properties is possible, in particular for a short time during the drying. This is necessary for an optimum formation of a film by film-forming. Finally, the film-forming auxiliary substances can evaporate, in particular when drying the wet film and the dry film formed therefrom. The surface of the coating is then no longer tacky, as it would otherwise permanently be in the case of coatings of low glass transition temperature T_{g} and minimum film-forming temperature MFT without using film-forming auxiliary substances, since the minimum film-forming temperature MFT rises again during and/or after the film-forming on account of the evaporation of the film-forming auxiliary substances, and since a hardness and a flexibility of the synthetic resins similar to those that were originally found in these synthetic resins is then re-established after the drying and after the film-forming.

In the film-forming the organic cores (particles) also lose their particulate structure if their glass transition temperature T_{g} and minimum film-forming temperature MFT are sufficiently close to one another and if corresponding temperatures are achieved and/or exceeded. In this connection it has now been found that the formed organic films are particularly homogeneously compacted and the constituents of the conductive polymer can be distributed therein in a micro-dispersed and particularly fine and homogeneous manner. The various types of conductive polymer-containing particles, in particular the typical core-shell particles, the fine particles consisting substantially of conductive polymer and/or the so-called “coupling agent particles” that may possibly be found in a particle mixture, can in the formation of the film under suitable conditions—for example if they are present in the form of micelles or can be converted into the latter—be split up or, in particular where these micelles are dissolved in the coating that is or has undergone film formation, may be distributed in a micro-dispersed and often homogeneous manner. The micro-dispersed particles of the conductive polymers, which then for example are formed from the particle shells in the film-forming, often have a size in the range from 5 to 100 nm. If however the glass transition temperature T_{g} or minimum film-forming temperature MFT of the organic particles was significantly higher than the glass transition temperature T_{g} or minimum film-forming temperature MFT of the organic binders in which the organic particles are distributed, then the organic particles may remain substantially unchanged and their shell of conductive polymer may likewise remain substantially unchanged.

For the process according to the invention for producing a binder-rich coating containing conductive polymers, coatings are particularly preferred that undergo film-forming/are film-formed largely or completely during drying and/or (possibly subsequently) are chemically and/or chemically-thermally cured and/or free-radically crosslinked. Film-forming within the context of this application means the formation, in particular on the metallic surface, of a homogeneous film of the binder-rich composition and the coated organic particles contained therein, under the influence of thermal energy. In this case a coherent homogeneous film is formed from the preferably elastic and soft binder particles. The start of the film-forming process depends on the glass transition temperature of the organic polymer particles and/or of the binders that are used. Preferably the glass transition temperature of the organic polymer particles and/or of the binders are close to one another, so that both can undergo homogeneous film-forming at the same temperature. In this connection it should be ensured that the film-formability of a film-formable composition is not affected by the incorporated particles.

The contents of film-forming auxiliary substances, referred to the solids content of the composition containing a binder system, are often in the range from 0.01 to 50 wt. %, particularly preferably in the range from 0.1 to 30 wt. %, often in the range from 0.1 to 10 wt. %, from 0.1 to 5 wt. % or from 0.1 to 2 wt. %, in particular for example 0.15, 0.21, 0.27, 0.33, 0.39, 0.45, 0.51, 0.57, 0.63 0.70, 0.76, 0.82, 0.88, 0.94, 1, 1.1, 1.2, 1.3, 1.4, 1.5, 1.6, 1.7, 1.8, 1.9, 2, 2.2, 2.4 or 2.7 wt. %. The softer and more elastic the synthetic resins that are used, the lower the content of film-forming auxiliary substances may be held; conversely, the harder (more rigid) and stronger the synthetic resins that are used, then often the content of film-forming auxiliary substances is chosen to be higher.

The aqueous, organic polymer-containing composition may in particular be used with a pH value in the range from 0.5 to 12. Particularly preferred when using a binder system of cationically stabilised polymers is a pH value in the range from 1 to 7, in particular in the range from 2 to 6 or from 3.5 to 4.5, and when using a binder system of anionically stabilised polymers, a pH value in the range from 6 to 11, in particular in the range from 7 to 10 or from 7.5 to 8.5, or when using an ionically non-stabilised binder system, a pH value in the range from 1 to 11.

Preferably the composition according to the invention is applied by roller coating, flow coating, knife coating, sprinkling, spray coating, brushing and/or dipping, and if necessary followed by squeezing off with a roller.

Preferably the aqueous composition is applied at a temperature in the range from 5° to 50° C. to the metallic surface if the said metallic surface during the application of the coating is maintained at temperatures in the range from 5° to 120° C., and/or if the coated metallic surface is dried at a temperature in the range from 20° to 400° C. PMT (peak metal temperature).

In some embodiment variations strips are coated with a composition according to the invention and wound into a coil, if necessary after cooling to a temperature in particular in the range from 20° to 70° C.

Preferably the metallic surface to be coated is, before the coating with at least one composition according to claim 1 or 2, cleaned, pickled, rinsed, provided with a passivation layer, treatment layer, pre-treatment layer, oil layer and/or with a thin or very thin coating that largely contains conductive polymer and is only limitedly or is completely closed, and if necessary is subsequently at least partly freed from this layer.

Preferably the coated metallic surface after the coating with a composition according to claim 1 or 2 is provided, with at least one further coating based on a post-rinse solution, organic polymer, paint, colour-imparting paint, adhesive, adhesive carrier and/or oil. Post-rinse solutions often have the object of sealing, passivating and/or modifying an already applied coating.

Preferably the coated metal parts, strips, strip sections, wires or profiled sections are shaped, painted, coated with polymers such as e.g. PVC, printed, bonded, hot-soldered, welded and/or joined to one another or to other elements by clinching or other joining techniques.

The dried and optionally also hardened coating for protecting a metallic surface has in many cases a pendulum hardness in the range from 30 to 190 sec, measured with a Konig pendulum hardness tester according to DIN 53157. In many cases this coating has such a flexibility that, when bent over a conical mandrel in a mandrel bending test carried out very largely according to DIN ISO 6860 for a mandrel of 3.2 mm to 38 mm diameter—however without tearing the surface—no cracks longer than 2 mm are formed, which can be detected in the subsequent wetting with copper sulphate by the change in colour as a result of deposition of copper on the cracked metallic surface.

The layer thickness of the binder-rich, film-formed and/or also hardened coating that is produced with the binder-rich composition according to the invention, may in principle be adjusted in the range from 0.2 to 120 μm. Depending on the application, “peaks” of the layer thickness of this coating appear however, for example in the range from 0.1 to 3 μm, from 0.3 to 5 μm, from 0.5 to 10 μm, from 2 to 20 μm and from 5 to 50 μm. This coating may optionally also consist of several, successively applied individual layers. A layer system of for example 2, 3, 4 or 5 layers may then often have an overall thickness in the range from 10 to 200 μm, in many cases in the range from 20 to 150 μm.

The electrical conductivity of the conductive polymer-containing coatings according to the invention on metallic surfaces may in particular be in the range from 10⁻⁸ to 0.1 Siemens/cm, in particular in the range from 10⁻⁶ to 10⁻¹ Siemens/cm, often in the range from 10⁻⁵ to 10⁻¹ Siemens/cm, and possibly in the range from 10⁻⁴ to 10⁻² Siemens/cm.

If powder of conductive polymer is incorporated into an organic composition, such as for example into a paint or a paint-like, predominantly or wholly organic coating, then the colour of the powder particles without a bright core is substantially more intense and, when added to an organic coating composition, can impart an undesirable colour impression and/or a speckled appearance or a colour change to the coating formed therefrom. The electrical conductivity of the coatings produced in this way may not be uniform, and may therefore depending on the circumstances provide an incomplete, namely locally variably good or poor corrosion protection: the percolation threshold above which a conductivity pathway exists is in this connection higher.

In preliminary experiments particles based on silicon dioxide nanoparticle have proved to be particularly anti-corrosive in a coating for metallic surfaces if they have been coated with compositions based on salicylate, titanium and/or zirconium complex fluoride with Fe³⁺, H₂O₂, molybdate and/or phosphomolybdate as oxidising agent, as well as with conductive polymer based on polypyrrole and have been incorporated together with these particles in a matrix based on acidic polymer containing styrene acrylate. In this case almost the same level of corrosion protection provided by commercial chromate coatings was achieved on hot-dip galvanised steel sheets.

Such chemical systems with conductive polymer are of particular interest for the two-dimensional coating of metallic substrates, for example as a constituent of a composition that may serve in particular as a passivation, as a pre-treatment, as a pre-treatment primer (=primer that is applied to the metallic surface in a different way to the practically always conventional way without any pre-treatment layer) or as a primer on at least one pre-treatment layer.

Passivation in the context of the present application is understood on the one hand to mean a coating which is or is being applied to a metallic coating and which for a relatively long time is not coated or is never coated with at least one subsequent, for example organic, coating such as for example a primer, a paint or a paint system, and should therefore often have an increased corrosion resistance, and on the other hand within the context of the description of the chemical effects denotes the corrosion protection action as passivation. Pre-treatment within the context of the present application is understood to mean a coating that is or is being applied to a metallic surface, onto which at least one organic coating, such as for example a paint system, is then applied. Pre-treatment primer within the context of the present application is understood to denote a coating that is or is being applied to a metallic surface and which at the same time combines the functions of a pre-treatment and a primer in a single coating. Primer is understood in this connection to mean a first organic coating, such as for example a first paint coat.

### Use of the Conductively Coated Particles and Organic Coatings

The conductive polymer-containing particles may be used to coat surfaces of metallic strips, wires, profiled sections and parts for the purposes of corrosion protection, to coat surfaces in order to avoid an anti-static charge and/or absorption of dirt, as an electrode material in sensors, in batteries, as an electrode material with catalytic properties, as a dielectric additive for conductive coatings and compositions, as a filler material in electrical insulation technology, as a colouring agent, or for conductor smoothing layers.

The article coated by the process according to the invention, such as for example a strip, a wire, a profiled section or a part, may be used as a wire coil, wire mesh, steel strip, metal sheet, lining, cladding, screening, car body or car body part, part of an aircraft, trailer, mobile home or flying object, as a covering, housing, lamp, light, traffic light element, piece of furniture or furniture element, element of domestic equipment, frame, profiled section, moulded part, moulded part of complicated geometry, guardrail, heating body or fence element, vehicle bumper, part of or together with at least one tube and/or a profiled section, window, door or bicycle frame, or a small part such as for example a screw, nut, flange, spring or spectacles frame.

### Advantages and Surprising Effects of the Particles and Systems

The processes according to the invention for the production of a conductive coating are particularly suitable for technical use, since even with very small amounts of the comparatively expensive educts large amounts of particles can be coated in process steps that are very simple, and with less expenditure on apparatus and equipment compared to other coating processes. With the processes of the prior art which lead to similar coatings, the addition of a coupling agent such as for example a silane, the incorporation of a so-called spacer (distance maintainer) such as for example an alkyl chain into the educt, the addition of stabilisers based on water-soluble polymers, such as for example hydroxymethylcellulose, and/or the addition of surfactant(s) to the composition before the oxidation are however advantageous, contrary to the processes according to the invention, in order to effect a better adhesion of the coating to the metallic surface. The addition of a coupling agent into a mixture sometimes proves problematical according to the prior art, since a special coupling agent has to be developed for each type of particle: an addition of for example surfactant(s) to the composition before the oxidation is however normally not necessary in the process according to the invention.

Surprisingly, the release and migration of the anions from the conductive polymer to the region undergoing corrosion and the hoped-for anti-corrosive action of the coatings according to the invention were successfully detected not only in very specific tests, such as for example with a scanning Kelvin probe (SKP), but the accumulation of the released anti-corrosive anions in the region undergoing corrosion as well as a significant increase in the corrosion protection of metallic substrates with an organic coating containing conductive polymer could also be detected in the macroscopic range with practice-oriented samples and tests, such as for example in the salt spray test.

Surprisingly, the process for coating metallic surfaces with a coating that includes conductive polymer-containing particles and a binder system could be designed and implemented simply and efficiently. In this connection relatively large surfaces of metallic substrates could be coated with relatively small amounts of conductive polymers.

Surprisingly, the conductive polymer could be distributed simply, stably and uniformly in a binder-rich composition with the aid of the conductive polymer-containing particles, in particular in film-forming.

Surprisingly, the choice of the anions that could be incorporated in the chemical polymerisation of the conductive polymers was virtually unrestricted.

Surprisingly, the particles coated with conductive polymer were stable in wide pH ranges on storage in a liquid medium and were also more stable than expected in these ranges, with the result that no deactivation of the conductive polymer was observed.

Surprisingly, the conductive polymer-containing particles are mechanically extremely stable, and their shells adhere very well to the particles, so that no damage was detected also in ultrasound treatments, and no or no substantial damage was observed even on prolonged deposition of the conductive polymers on particles in the mixture under the action of ultrasound.

It was also surprising that coated particles that had precipitated or gelled on the floor of the vessel from the initially stable dispersion could be redispersed again and could then be incorporated without any disadvantages in a substantially organic dispersion of a paint-like composition and could subsequently be incorporated in a substantially organic coating.

### EXAMPLES AND COMPARISON EXAMPLES

The examples described hereinafter are intended to illustrate the subject-matter of the invention by way of example.

1. Preparation Procedure of the Conductive Polymers and Coating of Inorganic Particles with Variation in the Composition of the Mixture:

The preparation of the conductive polymers and at the same time the coating of the inorganic particles were carried out in a one-pot process at a temperature that was maintained constant in each case in the range from 50° to 60° C. over the course of the reactions.

The educt mixture was prepared by adding to 100 ml of distilled water, while stirring, first of all isopropanol and in each case 10 to 15 g of a powder selected from Al₂O₃, BaSO₄, CaCO₃, CuO, SiO₂, SnO₂, TiO₂ as anatase or rutile, ZnO, coarsely crystalline biotite mica, prepared montmorillonite, quartz-rich seasand, potter's clay and in addition also pretreated cellulose powder suitable for column chromatography. 0.1 to 0.5 ml of conc. sulphuric acid was then added in order to adjust the pH to values in the range from 4 to 6, this acid also serving at the same time as a solution aid for molybdic acid and monomer/oligomer. This was followed by the addition of 0.3 ml of the monomer/oligomer dissolved in 20 to 50 ml of isopropanol at room temperature. As educt there was used in each case an educt selected from pyrrole, N-methylepyrrole and ethylenedioxythiophene. After stirring for 15 to 20 minutes an aqueous molybdic acid solution (H₂MoO₄) of 1.5 to 3 g/l, preheated to the mixture temperature, and containing about 20% of isopropanol, was added. After stirring for a further 30 to 150 minutes the coated inorganic particles and the particles of conductive polymer formed in the dispersion were separated by filtering off excess solvent mixture and oxidising agent. The particles were then dried for 20 to 30 minutes at 60° to 80° C. in a drying cabinet, a dry filter cake being formed. The filter cake was compacted in a mortar and largely homogeneously ground up over 10 to 15 minutes. Alternatively a ball mill was used in some cases. The ground product contained fully and partially coated inorganic particles, isolated residues of the coating shell, particles of conductive polymer, and uncoated inorganic particles (particle mixture). Using a light microscope, it was estimated that in each case about 85 to 95% of the visible particles were conductively coated particles. In principle inorganic particles with a mean particle size in the range from 5 nm to 5 mm could be used in this connection. During the grinding the inorganic particles were, depending on their state, not ground down or ground down only to a small extent. With particles larger than about 100 to 200 nm the particle distributions of the inorganic particles lay in the broad range of the particle distribution, and below these values were almost monodispersed. Only the particles below about 100 nm were substantially spherical. The coating of the particles had a layer thickness in the range from 2 to 10 nm, seen in a transmission electron microscope. The contents of conductive polymer were determined by thermogravimetry and were in the range from 3 to 10 wt. % of the dry particle mixture. An electrical conductivity and thus an increased level of doping was achieved in each test. The coating of the conductive polymers on the particles (core-shell particles) adhered well, so that the coating was also not rapidly abraded or ground off, not even in an ultrasound bath. A large number of tests were carried out, a small number of which together with the relevant data are shown in Table 1.

In addition, in complementary tests the particle mixture was added to a completely water-free ethanolic solution or to an ethyl acetate solution and dispersed in an ultrasound bath, following which two metal sheets were suspended in this dispersion and the coated conductive particles were deposited on the cathode metal sheet by cataphoresis, as in the case of electro-dipcoating, under a voltage in the range from 10 to 100 V at a current in the range from 2 to 20 mA over a time of 1 to 5 minutes. The cataphoresis did not represent a risk of corrosion for the metallic bodies to be coated—which is not the case with anaphoresis or electropolarisation. A very uniform, thin, strongly adherent and in some cases complete coating on both sides of the metal sheets was thereby obtained with the particle mixture. The coated metal sheets were then dried. The layer thicknesses were estimated to be in the range from 2 to 15 μm. This coating on the metal sheets was significantly better than if the particle mixture had been applied for example as a dispersion. The fine structure of the coating on the metal sheets was basically determined by the morphology of the incorporated coated particles. In this connection it was surprising that the conductive polymer in all stages of the at times somewhat drastic treatment did not suffer any deterioration of its properties, in particular its electrical conductivity, its chemical and thermal stability, as well as its anti-corrosive properties.

TABLE 1
Compositions of the mixtures with inorganic particles and properties of the coatings

| Contents in μl, ml or g | B 1 | B 2 | B 3 | B 4 | B 5 | B 6 | B 7 | B 8 | B 9 | B 10 | B 11 |
|---|---|---|---|---|---|---|---|---|---|---|---|
| Pyrrole in μl | 300 | 300 | 300 | 300 | 300 | 300 | 300 | 300 | | | |
| Ethylenedioxythiophene in μl | | | | | | | | | 300 | 300 | 300 |
| Benzoate in g | 6 | | | | | | | | | | |
| Nitrosalicylate in g | | 6 | | | | | | 3 | | | |
| Hexafluorotitanate in g | | | 6 | | | | | | | | |
| Salicylate in g | | | | 6 | | 6 | | | | | |
| Tartrate in g | | | | | 6 | | 6 | | | | |
| Molybdate* in g | | | | 3 | 3 | | | 2 | 3 | 3 | 3 |
| Tungstate* in g | | | | | | 3 | 3 | | | | |
| Ce⁴⁺-Sulfate in g | 3 | | | | | | | | | | |
| Fe³⁺-Nitrate in g | | 3 | | | | | | | | | |
| Fe³⁺-Sulfate in g | | | 3 | | | | | | | | |
| Al₂O₃ C, Degussa, 12 nm, in g | 15 | 15 | 15 | 15 | 15 | 15 | 15 | 15 | 15 | 15 | 15 |
| Isopropanol in ml | 100 | 100 | 100 | 100 | 100 | 100 | 100 | 100 | 100 | | 100 |
| Dist. Water in ml | 150 | 150 | 150 | 150 | 150 | 150 | 150 | 150 | 150 | 250 | 200 |
| pH value | 4-6 | 4-6 | 4-6 | 4-6 | 4-6 | 4-6 | 4-6 | 4-6 | 4-6 | 4-6 | 4-6 |
| Temperature in ° C. | 40-60 | 40-60 | 40-60 | 40-60 | 40-60 | 40-60 | 40-60 | 40-60 | 40-60 | 40-60 | 40-60 |
| Electrical conductivity in | n.m. | 10⁻² | n.m. | n.m. | n.m. | n.m. | n.m. | n.m. | n.m. | n.m. | n.m. |
| S/cm | | | | | | | | | | | |
| Colour | blue | blue | grey | grey | grey- | grey | grey- | grey- | grey- | grey- | grey- |
| | | | | | blue | | blue | blue | blue | blue | blue |

n.m. = not measured
*anions with an oxidising agent action

2. Preparation Procedure and Coating of Organic Particles with Variations of the Composition of the Mixture

An aqueous educt mixture containing all the constituents including the organic particles and possibly a salt that does not exhibit any oxidising properties, but whose anion has anti-corrosive properties, optionally also with the addition of 1 to 10 wt. % of ethanol, was prepared for the production of the conductive polymer—with the exception of the oxidising agent. The respective compositions are given in Table 2. If the salt exhibited oxidising properties and the anion of the salt exhibited anti-corrosive properties, the salt was instead added only after the homogenisation. When using molybdate or tungstate as oxidising agent the educt mixture was heated to a temperature of 50° C. before the addition of the molybdate or tungstate, if the pH value was above 3. The pH value was adjusted with phosphoric acid. The educt mixture was stirred for ca. 20 minutes at this temperature in order to allow the constituents to thoroughly mix, since otherwise a phase separation could occur. A good homogeneity of the solution (educt mixture) already had to exist when the oxidising agent was added.

As organic particles, polystyrene, polystyrene-butyl acrylate or polybutyl acrylate with defined compositions and glass transition temperatures T_{g} were used, which were added as aqueous dispersions. The organic particles had almost monodisperse particle size distributions and were largely spherical. The mean particle size distribution could be chosen between 150 and 500 nm, wherein for each of these distributions the glass transition temperature T_{g} as well as the chemical composition were varied.

During the further stirring at the chosen temperature oxidising agent was added in significant excess, whereby the polymerisation of the educt, for example based on pyrrole, occurred. The originally white dispersion changed after a short time to a grey colour and later black. If the concentrations were suitably chosen, no flocculations occurred and no agglomerates were formed. The reaction mixture was stirred for at least 4 hours in order to permit an as complete a reaction as possible. The mobile anti-corrosive anion of the oxidising agent or of the salt was in this connection incorporated as doping ion into the conductive polymers formed from monomer/oligomer. The coated particles could then easily be separated, for example by centrifugation, from the remaining solution or dispersion. At the same time the excess of oxidising agent and or unreacted pyrrole molecules was also separated since these substances could otherwise have interfered, for example by salt precipitation, during the drying. Alternatively an ultracentrifugation (dialysis) was chosen, the process being carried out against distilled water. Ultracentrifugation is more effective than centrifugation. The dialysis was carried out for 48 hours with a cellulose membrane (10,000 MWCO). The coated particles could then be dried if necessary, in order to obtain a powder, for example for analytical investigations, or to remove organic solvents such as alcohol. A redispersion in water was not necessary, except in the case of the coated inorganic particles. Since a subsequent mixing with base polymers was envisaged, a drying operation was not necessary. The ready-for-use produced dispersion (product mixture) was found to be stable even for one year.

The base polymer was added to the enriched coated organic particles. This composition was then stirred for 10 minutes until a thorough mixing had been achieved. This composition could be used immediately as an organic coating mixture—in particular as a chromium-free primer—and, corresponding to the application conditions of the base polymers, could be applied to metallic surfaces and then undergo film formation.

TABLE 2
Compositions of the mixtures with organic particles and properties of the coatings

| Contents in ml or g | B 21 | B 22 | B 23 | B 24 | B 25 | B 26 | B 27 | B 28 | B 29 | B 30 | B 31 | B 32 | B 33 | B 34 |
|---|---|---|---|---|---|---|---|---|---|---|---|---|---|---|
| Dist. water in ml | 100 | 100 | 100 | 100 | 100 | 100 | 100 | 100 | 100 | 100 | 100 | 100 | 100 | 100 |
| Ethanol in ml | 1 | 3 | 5 | 10 | | | | | 5 | 5 | 5 | 5 | 5 | 5 |
| Isopropanol in ml | | | | | 1 | 3 | 5 | 10 | | | | | | |
| Pyrrole in g | 0.1 | 0.5 | 1.5 | 5 | 0.1 | 0.5 | 1.5 | 5 | | | | | | |
| N-Methylpyrrole in g | | | | | | | | | 1.5 | | | | | |
| 3-Methoxypyrrole in g | | | | | | | | | | 1.5 | | | | |
| 3-Methylpyrrole in g | | | | | | | | | | | 1.5 | | | |
| 3-Ethylpyrrole in g | | | | | | | | | | | | 1.5 | | |
| 3-Phenylpyrrole in g | | | | | | | | | | | | | 1.5 | |
| Ethylenedioxythiophene | | | | | | | | | | | | | | 1.5 |
| in g | | | | | | | | | | | | | | |
| Benzoate in g | 3.0 | 3.0 | 3.0 | 3.0 | 3.0 | 3.0 | 3.0 | 3.0 | 3.0 | 3.0 | 3.0 | 3.0 | 3.0 | 3.0 |
| NH₄S₂O₈ in g | 0.1 | 0.5 | 1.5 | 5 | 0.1 | 0.5 | 1.5 | 5 | 1.5 | 1.5 | 1.5 | 1.5 | 1.5 | 1.5 |
| Polystyrene, in g | 10 | 10 | 10 | 10 | 10 | 10 | 10 | 10 | 10 | 10 | 10 | 10 | 10 | 10 |
| Mean particle size in nm | 300 | 300 | 300 | 300 | 300 | 300 | 300 | 300 | 300 | 300 | 300 | 300 | 300 | 300 |
| Glass transition temp. | 100 | 100 | 100 | 100 | 100 | 100 | 100 | 100 | 100 | 100 | 100 | 100 | 100 | 100 |
| T_{g} of the particles ° C. | | | | | | | | | | | | | | |
| pH value | 3 | 3 | 3 | 3 | 3 | 3 | 3 | 3 | 3 | 3 | 3 | 3 | 3 | 3 |
| Temperature in ° C. | 25 | 25 | 25 | 25 | 25 | 25 | 25 | 25 | 25 | 25 | 25 | 25 | 25 | 25 |
| Size of organic coated | 305 | 310 | 315 | 320 | 305 | 310 | 315 | 320 | 315 | 315 | 315 | 315 | 315 | 315 |
| particles in nm | | | | | | | | | | | | | | |
| Electrical conductivity | 10⁻⁶ | 10⁻⁵ | 10⁻⁴ | 10⁻³ | 10⁻⁶ | 10⁻⁵ | 10⁻⁴ | 10⁻³ | n.m. | n.m. | n.m. | n.m. | n.m. | n.m. |
| in S/cm | | | | | | | | | | | | | | |
| Degree of doping ca. in % | 30 | 30 | 30 | 30 | 30 | 30 | 30 | 30 | n.m. | n.m. | n.m. | n.m. | n.m. | n.m. |

| Contents in ml or g | B 35 | B 36 | B 37 | B 38 | B 39 | B 40 | B 41 | B 42 | B 43 | B 44 | B 45 | B 46 | B 47 | B 48 | B 49 |
|---|---|---|---|---|---|---|---|---|---|---|---|---|---|---|---|
| Dist. water in ml | 100 | 100 | 100 | 100 | 100 | 100 | 100 | 100 | 100 | 100 | 100 | 100 | 100 | 100 | 100 |
| Ethanol in ml | 5 | 5 | 5 | 5 | 5 | 5 | 5 | 5 | 5 | 5 | 5 | 5 | 5 | 5 | 5 |
| Isopropanol in ml | | | | | | | | | | | | | | | |
| Pyrrole in g | 1.5 | 1.5 | 1.5 | 1.5 | 1.5 | 1.5 | 1.5 | 1.5 | 1.5 | 1.5 | 1.5 | | | | 1.5 |
| N-Methylpyrrole in g | | | | | | | | | | | | 1.9 | 1.9 | 1.9 | |
| Molybdate* in g | | 1.65 | 3.30 | 10.2 | 13.6 | 20.3 | 10.2 | 10.2 | 10.2 | 10.2 | 10.2 | 10.2 | 13.6 | 20.3 | 10.2 |
| Tungstate* in g | 3.3 | | | | | | | | | | | | | | |
| Polystyrene, in g | 10 | 10 | 10 | 10 | 10 | 10 | | | | | | | | | |
| Polystyrene-butyl acrylate in g | | | | | | | 10 | 10 | 10 | 10 | 10 | 10 | 10 | 10 | |
| Polybutyl acrylate in g | | | | | | | | | | | | | | | 10 |
| Styrene:butyl acrylate ratio | | | | | | | 9:1 | 5:1 | 2:5 | 3:5 | 4:5 | 3:5 | 3:5 | 3:5 | |
| Mean particle size in nm | 300 | 300 | 300 | 300 | 300 | 300 | 300 | 300 | 300 | 300 | 300 | 300 | 300 | 300 | 300 |
| Glass transition temp. T_{g} of the | 100 | 100 | 100 | 100 | 100 | 100 | 80 | 60 | 40 | 20 | −10 | 20 | 20 | 20 | −40 |
| particles ° C. | | | | | | | | | | | | | | | |
| pH value | 2 | 2 | 2 | 2 | 2 | 2 | 2 | 2 | 2 | 2 | 2 | 2 | 2 | 2 | 2 |
| Temperature in ° C. | 25 | 25 | 25 | 25 | 25 | 25 | 25 | 25 | 25 | 25 | 25 | 25 | 25 | 25 | 25 |
| Size of organic coated particles in nm | 315 | 315 | 315 | 315 | 315 | 315 | 315 | 315 | 315 | 315 | 315 | 315 | 315 | 315 | 315 |
| Electrical conductivity in S/cm | n.m. | n.m. | n.m. | n.m. | n.m. | n.m. | n.m. | n.m. | n.m. | n.m. | n.m. | n.m. | n.m. | n.m. | n.m. |
| Degree of doping ca. in % | 17 | 15 | 19 | 23 | 27 | 30 | 23 | 23 | 23 | 23 | 23 | 18 | 21 | 24 | 23 |

| Contents in ml or g | B 50 | B 51 | B 52 | B 53 | B 54 | B 55 | B 56 | B 57 |
|---|---|---|---|---|---|---|---|---|
| Dist. water in ml | 100 | 100 | 100 | 100 | 100 | 100 | 100 | 100 |
| Ethanol in ml | 5 | 5 | 5 | 5 | 5 | 5 | 5 | 5 |
| Pyrrole in g | 1.5 | 1.5 | 1.5 | 1.5 | 1.5 | 1.5 | 1.5 | 1.5 |
| Molybdate* in g | 3.41 | 3.41 | 3.41 | 3.41 | | | | |
| Tungstate* in g | | | | | 3.30 | 3.30 | 3.30 | 3.30 |
| Polystyrene-butyl acrylate in g | 10 | 10 | 10 | 10 | 10 | 10 | 10 | 10 |
| Styrene:butyl acrylate ratio | 3:5 | 3:5 | 3:5 | 3:5 | 3:5 | 3:5 | 3:5 | 3:5 |
| Mean particle size in nm | 300 | 300 | 300 | 300 | 300 | 300 | 300 | 300 |
| Glass transition temp. T_{g} of the | 20 | 20 | 20 | 20 | 20 | 20 | 20 | 20 |
| particles ° C. | | | | | | | | |
| pH value | 1 | 3 | 4 | 5 | 1 | 3 | 4 | 5 |
| Glass transition temp. T_{g} of the | 25 | 25 | 50 | 50 | 25 | 25 | 50 | 50 |
| particles ° C. | | | | | | | | |
| Size of organic coated particles in nm | 315 | 315 | 315 | 315 | 315 | 315 | 315 | 315 |
| Electrical conductivity in S/cm | n.m. | n.m. | n.m. | n.m. | n.m. | n.m. | n.m. | n.m. |
| Degree of doping ca. in % | 28 | 28 | 28 | 28 | 28 | 28 | 28 | 28 |

*anions with an oxidising agent action
n.m. = not measured

The mean particle size of the uncoated and coated organic particles was determined with a scanning electron microscope. The electrical conductivity was measured on the interdigital structures (comb-like electrodes) by means of the two-point method on pressed articles of doped conductive polymer. All conductively coated organic particles were black.

Of the educt solutions, those containing pyrrole and N-methylpyrrole had proved particularly suitable, these particularly preferably having been applied to organic particles based on polystyrene/butyl acrylate in a ratio of 50 to 90 wt. % styrene fraction. In particular molybdate or tungstate proved advantageous as oxidising agent and at the same time as anions. With molybdate and tungstate it was found to be important that an almost maximum doping of the conductive polymer up to about 28% referred to the polymer unit is possible and is also advantageous.

In the Examples B21 to B28 the layer thickness of the coating of conductive polymer also increased, for example from 5 nm to 10 nm, in line with the increasing content of pyrrole. In Example B34 a thiophene was used instead of pyrrole. Tungstate was added in Example B35, in contrast to B23. Molybdate was used in the Examples B36 to B40, in contrast to B23 and B35. The concentration of the mobile anti-corrosive anions is in this case higher and the depot effect is accordingly better. In the Examples B41 to B48 the film-formability of the particles was changed on account of the variation of the composition of the organic particles: the film-formability is best with B43 and B44, whereas the film-formability with glass transition temperatures T_{g} of less than 20° could no longer be controlled so well, unless the process was carried out at temperatures below room temperature. In the Examples B50 to B57 the pH and the oxidising agent were varied, better results being achieved at pH values of 4 and 5 for molybdate, and at a pH value of 5 for tungstate. With regard to the mobility of the mobile anti-corrosive anions, Examples B52, B53 and B57 should show the best mobility of the anions since these anions are particularly small and at higher pH values there is less tendency to form large polyanions.

3. Preparation Procedure and Coating of Organic Particles with Variation of the Oxidising Agent

In these Examples the second preparation procedure was basically employed.

The educt solution was prepared in the initial work stages by adding to 50 ml of distilled water, first of all a total of 50 g of an aqueous dispersion of polystyrene and/or polybutyl acrylate with a content of 20 wt. % of such organic particles of about 350 nm mean size, and followed by 1.4 g of freshly distilled pyrrole. In further tests pyrrole was replaced by N-methylpyrrole. The solution was stirred for 20 minutes at room temperature in order to homogenise the mixture.

An oxidising agent solution was then prepared by dissolving in 50 ml of water 0.1 to 1 mole of oxidising agent such as a) phosphomolybdate or b) H₂O₂ with ≦10⁻⁴ molar Fe³⁺ chloride with H₂O₂ in excess. This solution was then added dropwise after the homogenisation to the educt solution. The resultant mixture was then stirred for 4 to 6 hours at room temperature. In the dispersion ca. 10 nm thick coatings of polypyrrole were formed in this way on the organic particles. Also, before the addition of the oxidising agent, in a) the anion of the oxidising agent was incorporated as doping ion into the polypyrrole or into a corresponding derivative, whereas in b) before the addition of the oxidising agent in each case an arbitrary anti-corrosive mobile anion (molybdate, hexafluorotitanate, hexafluorozirconate, tungstate) was in addition added to the educt mixture.

The reaction mixture was then dialysed for 48 hour through a cellulose membrane with 10,000 MWCO against doubly distilled water, in order to separate not fully reacted educts, oxidising agent and anions. The particles were provided with coatings in the range from 5 to 20 nm thick. The dispersions thereby obtained were stable and usable after more than six months.

### 4. Preparation Procedure for Producing “Coupling Agent Particles” Based on Conductive Polymers

An aqueous, 5% ethanol-containing educt mixture based on coupling group-substituted monomer/oligomer with monomer/oligomer that was synthesised from the same monomer/oligomer, namely pyrrole, was prepared in the aqueous solution at room temperature. An unbranched alkylphosphonic acid with 10 or 12 C atoms was used as coupling groups. In addition a salt of the mobile anti-corrosive anion, ammonium molybdate, was added to the solution. The molybdate served at the same time as oxidising agent. The mixture was stirred for the whole time. The process was carried out at pH values in the range from 2.5 to 4, the pH value being adjusted via the content of the alkylphosphonic acid. The pKₛ value of the coupling groups determines the pH value of the educt mixture and permits a micelle formation of the coupling group-substituted monomer/oligomer in the mixture. The emulsion polymerisation took place over 10 to 24 hours while stirring. The dispersion was purified by dialysis in order to obtain an alcohol-containing aqueous dispersion of the “coupling agent particles” largely free of excess anions and completely free of oxidising agent and not completely reacted monomer/oligomer. The dispersion contained substantially spherical “coupling agent particles”, the particle size distribution of which was almost monodisperse and the mean particle size of which could be adjusted arbitrarily in the range from 50 to 400 nm.

### 5. Production of Organic Coatings Using Particles Containing Conductive Polymer

The specified concentrations and compositions refer to the treatment solution itself and not to possibly used batch solutions of higher concentration. All concentration figures should be understood as solids fractions, i.e. the concentrations refer to the proportions by weight of the active components, regardless of whether the raw materials used were present in dilute or concentrated form, for example as aqueous solutions. In addition to the compositions listed hereinafter, in commercial practice it may be necessary or desirable to add further additives or to adapt the amounts correspondingly, for example either to increase the total amount of additives or to increase for example the amount of the antifoaming agent and/or of the flow control agent, such as for example a polysiloxane.

As synthetic resins there were used a styrene acrylate with a glass transition temperature in the range from 15° to 25° C. and with a mean particle size in the range from 120 to 180 nm, an acrylate-polyester-polyurethane copolymer with a blocking temperature in the range from 140° to 180° C. and a glass transition temperature in the range from 20° to 60° C., an ethylene-acrylate copolymer with a melting point in the range from 70° to 90° C., and with an acrylate-modified carboxyl group-containing polyester in particular with a number of OH groups in the range from 80 to 120 and with an acid number in the range from 50 to 90, calculated on the solid resin, which had also undergone curing, for example by addition of hexamethoxymethylmelamine with an acid number of less than 5. The styrene-butadiene copolymer has a glass transition temperature in the range from −20° to +20° C. and an acid number in the range from 5 to 30; on account of the content of carboxyl groups this copolymer can in addition be crosslinked, for example with melamine resins or with isocyanate-containing polymers. The copolymer based on epoxide-acrylate has an acid number in the range from 10 to 18 and a glass transition temperature between 25° and 40° C. This copolymer for the coating of, in particular, steel imparts to the coating according to the invention a better chemical resistance, in particular in the alkaline range, and improves the adhesion properties to the metallic substrate.

The pyrogenic silicic acid has a BET value in the range from 90 to 130 m²/g, and the colloidal silicon dioxide has a mean particle size in the range from 10 to 20 nm. The melamine-formaldehyde served as crosslinking partner for the carboxyl group-containing polyester resin. The oxidised polyethylene served as lubricant and mould release agent (wax) and had a melting point in the range from 125° to 165° C. The polysiloxane that was used was a polyether-modified dimethylpolysiloxane and served as wetting agent and flow control agent of the wet film during the application. The defoaming agent was a mixture of hydrocarbons, hydrophobic silicic acid, oxalated compounds, and non-ionogenic emulsifiers. A tripropylene glycol-mono N-butyl ether was used as long-chain alcohol for the film-forming.

### Examples 61 to 71 According to the Invention

Steel sheets that were obtained from commercially available cold-rolled steel strip that was subsequently alloy-galvanised for example with 55% AlZn (Galvalume®), which had been oiled to protect them during storage, were first of all degreased in an alkaline spray cleaner, rinsed with water, dried at elevated temperature and then treated with the aqueous composition according to the invention. In this connection a specific amount of the aqueous composition (bath solution) was applied by means of a rollcoater so that a wet film thickness of ca. 10 ml/m² was obtained. The wet film was then dried at temperatures in the range from 80° to 100° C. PMT, film-formed, and hardened. The bath solution consisted of the components of Table 3, wherein except for the so-called zero samples, which had only the compositions specified in Table 3, in addition in each case one type of the coated inorganic particles, coated organic particles or coupling agent particles listed in the preceding examples were also added respectively in amounts of 0.05, 0.3 and 1.5 parts by weight, which are also calculated above 100 parts by weight.

The constituents were mixed in the specified order, the additional particles being added as the penultimate or last component. The pH of the solution was then adjusted with ammonia solution to 8.2. The solution was dried after the application in a circulating air oven at ca. 90° C. PMT (peak metal temperature). The steel sheets treated in this way were then tested for their corrosion resistance and their mechanical properties.

TABLE 3
Composition of the bath liquids of all Examples and Comparison Examples:

| Content in parts | Example | | | | | | | | | | |
|---|---|---|---|---|---|---|---|---|---|---|---|
| by weight | B 61 | B 62 | B 63 | B 64 | B 65 | B 66 | B 67 | B 68 | B 69 | B 70 | B 71 |
| Water | 100 | 100 | 100 | 100 | 100 | 100 | 100 | 100 | 100 | 100 | 100 |
| Styrene acrylate | 6.40 | | | 1.80 | | 4.40 | | 1.82 | 1.70 | | |
| Acrylate-polyester- | | 6.40 | 3.00 | 2.60 | | | 4.40 | 2.56 | 2.53 | | |
| polyurethane-copolymer | | | | | | | | | | | |
| Ethylene-acrylate | | | 3.00 | 2.60 | 1.00 | 2.60 | 2.60 | 2.56 | 2.53 | 2.65 | 2.65 |
| copolymer | | | | | | | | | | | |
| Carboxyl group- | | | | | 5.70 | | | | | | |
| containing polyester | | | | | | | | | | | |
| Melamine-formaldehyde | | | | | 0.60 | | | | | | |
| Colloidal SiO₂ 10-20 nm | | 2.50 | 2.50 | 1.40 | 1.60 | 1.40 | 1.40 | 1.46 | 1.40 | 1.32 | 1.32 |
| Pyrogenic silicic acid | 2.50 | | | | | | | | | | |
| Oxidised polyethylene | 0.50 | 0.50 | 0.50 | 0.50 | 0.50 | 0.50 | 0.50 | 0.50 | 0.50 | 0.50 | 0.50 |
| Polysiloxane | 0.10 | 0.10 | 0.10 | 0.10 | 0.10 | 0.10 | 0.10 | 0.10 | 0.10 | 0.10 | 0.10 |
| Combination of silanes | | | 0.40 | | | | | | | | |
| Defoaming agent | 0.10 | 0.10 | 0.10 | 0.10 | 0.10 | 0.10 | 0.10 | 0.10 | 0.10 | 0.10 | 0.10 |
| Long-chain alcohol | 0.40 | 0.40 | 0.40 | 0.40 | 0.40 | 0.40 | 0.40 | 0.40 | 0.40 | 0.40 | 0.40 |
| Ammonium Zr carbonate | | | | 0.40 | | 0.40 | 0.40 | 0.40 | 0.40 | | |
| TPA amine complex | | | | 0.10 | | 0.10 | 0.10 | 0.10 | 0.10 | 0.48 | 0.48 |
| Carboxyl group- | | | | | | | | | | 4.25 | 2.15 |
| containing styrene- | | | | | | | | | | | |
| butadiene copolymer | | | | | | | | | | | |
| Epoxide-acrylate | | | | | | | | | | | 2.10 |
| copolymer | | | | | | | | | | | |
| Inorganic particles | | | | | | | | | | | |
| coated with conductive | | | | | | | | | | | |
| polymer | | | | | | | | | | | |
| Organic particles | | | | | | | | | | | |
| coated with conductive | | | | | | | | | | | |
| polymer | | | | | | | | | | | |
| Ammonium bichromate | | | | | | | | | 0.24 | | |

### 6. Production of Organic Coatings Using Conductive Polymer-Containing Particles Based on Polyacrylate

Steel sheets that were obtained from commercially available hot-dip galvanised steel strip, which had been oiled to protect them during storage, were first of all degreased in an alkaline spray cleaner, rinsed with water, dried at elevated temperature and then treated with the aqueous composition according to the invention. In this connection a specific amount of the aqueous composition (bath solution) was applied by means of a rollcoater so that a wet film thickness of ca. 10 ml/m² was obtained. The wet film was then dried at temperatures in the range from ca. 70° to 90° C. PMT, film-formed, and hardened. The bath solution consisted of the components of Table 4.

For the tests in an acidic binder system (Comparison Example VB81 to B91) a dispersion containing water and a small amount of alcohol, based on styrene-acrylate of pH 4.2, was mixed, while stirring vigorously, with a dispersion containing water and a small amount of isopropanol, based on nanoparticulate silicon dioxide from a silica sol coated with polypyrrole as well as with additives. Before the coating with the polypyrrole the nanoparticles had particle sizes mainly in the range from 10 to 30 nm, the coating having a layer thickness for example in the range from 2 to 6 nm. The solution was dried after the application in a circulating air oven at ca. 70° to 90° C. PMT (peak metal temperature). The steel sheets treated in this way were then tested for their corrosion resistance and their mechanical properties. In Comparison Example VB181 the metal sheets were coated without SiO₂ particles and without conductive polymer. All coatings exhibited a very good adhesion to the metallic surface. The Examples B82 to B91 according to the invention manifest a high corrosion protection, which can be attributed largely to the release effect of the anti-corrosive mobile anions and probably also to a cessation of the delamination of the regions undergoing corrosion.

In parallel to this, tests (VB 92, B 93, B 94, VB 95) were carried out in a corresponding manner in a basic synthetic resin system, in which this binder system was also tested with an addition of chromate.

In these preliminary and comparatively few tests, the corrosion resistance of the coatings according to the invention which included conductive polymer-containing particles instead of chromate is very close to the corrosion resistance of the typical chromate-containing coatings of the prior art.

TABLE 4
Composition of the bath liquids of all Examples and Comparison Examples:

| | Example | | | | | | | |
|---|---|---|---|---|---|---|---|---|
| Content in parts by weight | VB 81 | B 82 | B 83 | B 84 | B 85 | B 86 | B 87 | B 88 |
| Water with solvent content | 100 | 100 | 100 | 100 | 100 | 100 | 100 | 100 |
| Acidic styrene-acrylate | 15.52 | 12.82 | 14.04 | 12.82 | 14.04 | 12.82 | 12.82 | 12.82 |
| Particles of colloidal SiO₂ 10-30 nm coated with | — | 1.93 | 1.06 | 1.93 | 1.06 | 1.93 | 1.93 | 1.93 |
| conductive polymer with: | | | | | | | | |
| Anion content of TiF₆ | — | X | — | — | X | X | X | X |
| Anion content of ZrF₆ | — | — | — | X | — | — | — | — |
| Anion content of nitrosalicylate | — | — | X | — | — | — | — | — |
| Oxidising agent used for the production of the conductive | — | Fe³⁺/ | Fe³⁺/ | Fe³⁺/ | H₂MoO₄ | H₂MoO₄ | Fe³⁺/ | H₂MoO₄ |
| polymer | | H₂O₂ | H₂O₂ | H₂O₂ | | | H₂O₂ | |
| Film-forming auxiliary substance. | 0.58 | 0.48 | 0.53 | 0.48 | 0.53 | 0.48 | 0.48 | 0.48 |
| Wax | 1.02 | 0.85 | 0.93 | 0.85 | 0.93 | 0.85 | 0.85 | 0.85 |
| Wetting agent | 0.06 | 0.05 | 0.05 | 0.05 | 0.05 | 0.05 | 0.05 | 0.05 |
| Ammonium bichromate | — | — | — | — | — | — | — | — |
| 600 hrs constant weathering test: % surface corrosion | — | — | — | — | — | — | 20 | 20 |
| 1008 hrs constant weathering test: % surface corrosion | 10 | 0 | 0 | 0 | 0 | 5 | — | — |
| 24 hrs salt spray test: % surface corrosion | 80 | 10 | 5 | 5 | 3 | 3 | 40 | 40 |
| 120 hrs salt spray test: % surface corrosion | 100 | 50 | 50 | 50 | 15 | 40 | 80 | 100 |

| | Example | | | | | | |
|---|---|---|---|---|---|---|---|
| Content in parts by weight | B 89 | B 90 | B 91 | VB 92 | B 93 | B 94 | VB 95 |
| Water, optionally with solvent content | 100 | 100 | 100 | 100 | 100 | 100 | 100 |
| Acidic styrene-acrylate | 11.54 | 11.10 | 10.33 | — | — | — | — |
| Alkaline polymer/copolymer mixture based on acrylate, polyester, | — | — | — | 23.66 | 21.70 | 20.06 | 23.17 |
| polyurethane and styrene | | | | | | | |
| Particles of colloidal SiO₂ 10-30 nm coated with conductive | 0.44 | 0.84 | 1.56 | — | 0.91 | 1.69 | — |
| polymer with: | | | | | | | |
| Anion content of TiF₆ | X | X | X | — | — | — | — |
| Anion content of nitrosalicylate | — | — | — | — | X | X | — |
| Oxidising agent used for the production of the conductive polymer | Fe³⁺/ | Fe³⁺/ | Fe³⁺/ | — | H₂MoO₄ | H₂MoO₄ | — |
| | H₂O₂ | H₂O₂ | H₂O₂ | | | | |
| Film-forming auxiliary substance | 0.44 | 0.42 | 0.39 | 0.25 | 0.23 | 0.21 | 0.24 |
| Wax | 0.76 | 0.73 | 0.68 | 0.70 | 0.64 | 0.59 | 0.68 |
| Wetting agent | 0.04 | 0.04 | 0.04 | 0.05 | 0.05 | 0.04 | 0.05 |
| Ammonium bichromate | — | — | — | — | — | — | 0.39 |
| 360 hrs constant weathering test: % surface corrosion | 0 | 0 | 0 | 60 | 0-10 | 0-10 | 0-5 |
| 1008 hrs constant weathering test: % surface corrosion | — | — | — | 100 | 0-30 | 0-30 | 0-10 |
| 360 hrs constant weathering test: under-edge migration in mm | <1 | <1 | <1 | — | — | — | — |
| 24 hrs salt spray test: % surface corrosion | 0 | 0 | 0 | 100 | 60-100 | 60-100 | 0 |
| 120 hrs salt spray test: % surface corrosion | 10 | 0 | 0 | 100 | 100 | 100 | 0-10 |

1-30. (canceled)

31. A process comprising coating a metallic surface with an anti-corrosive composition that contains a conductive polymer, wherein the composition is a dispersion that contains at least one conductive polymer largely or wholly in particulate form and a binder system, wherein the conductive polymer is at least one polymer based on polyphenylene, polyfuran, polyimidazole, polyphenanthrene, polypyrrole, polythiophene or polythiophenylene, which is charged with anti-corrosive mobile anions.

32. The process of claim 31, comprising drying the coating and applying a second composition that is a dispersion and contains a binder system to the coated metallic surface

33. The process according to claim 31, wherein the conductive polymer-containing particles are selected from the group consisting of 1) typical coated particles that are partially or completely coated with conductive polymer, 2) particles that at least in part contain conductive polymer in their interior, 3) particles substantially or wholly comprising a conductive polymer, 4) coupling agent particles of conductive polymer which comprise at least one coupling-promoting chemical group on the molecule, 5) fractions of particle shells of conductive polymer or of conductive polymer-containing particles and 6) conductive polymer-containing particles formed separately without particle cores and that consist substantially or wholly of conductive polymer.

34. The process according to claim 31, wherein the mean particle size of the conductive-polymer-containing particles including their accumulations lies in the range from 10 nm to 20 μm or wherein the mean particle size of the conductive polymer-containing particles without agglomerates and without aggregates lies in the range from 10 nm to 10 μm.

35. The process according to claim 31, wherein the conductive polymer-containing particles are selected from the group consisting of a cluster, a nanoparticle, a nanotube, a fiber-like structure, a coiled structure, a porous structure and a solid particle.

36. The process according to claim 31, wherein the conductive polymer-containing inorganic particles are selected from the group of particles that consist of at least one substance substantially of in each case at least one boride, carbide, carbonate, cuprate, ferrate, fluoride, fluorosilicate, niobate, nitride, oxide, phosphate, phosphide, phosphosilicate, selenide, silicate, sulfate, sulphide, telluride, titanate, zirconate, at least one type of carbon, at least one alloy, of at least one metal or its mixed crystal, of mixtures or intergrowths.

37. The process according to claim 31, wherein the conductive polymer-containing organic particles are predominantly or wholly those that are selected from the group consisting of a polymer based on styrene, acrylate, methacrylate, polycarbonate, cellulose, polyepoxide, polyimide, polyether, polyurethane, siloxane, polysiloxane, polysilane and polysiloxane.

38. The process according to claim 31, wherein the at least one anion is selected from an anion based on a carboxylic acid, a hydroxycarboxylic acid, an oxycarboxylic acid, a dicarboxylic acid, a tricarboxylic acid, a di-substituted or tri-substituted arenecarboxylic acid, a meta- ortho- or para-substituted arenecarboxylic acid, an arene acid containing an amino, a nitro, a sulfonic (SO₃H—) or an OH group, sulfonic acids, a mineral oxyacid, a boron-containing acid, a manganese-containing acid, a molybdenum-containing acid, a phosphorus-containing acid, a phosphonic acid, a fluorosilicic acid, a silicic acid, an acid with a content of at least one element from the a rare earth or yttrium, a sulphur-containing acid, a titanium-containing acid, a vanadium-containing acid, a tungsten-containing acid, a tin-containing acid, a zirconium-containing acid, a salt thereof, an ester thereof and a mixture thereof.

39. The process according to claim 31, wherein at least one anion is selected from anions based on an alkylphosphonic acid, a arylphosphonic acid, benzoic acid, succinic acid, tetrafluorosilicic acid, hexafluorotitanic acid, hexafluorozirconic acid, gallic acid, hydroxyacetic acid, a silicic acid, a lactic acid, a molybdenum acid, a niobic acid, a nitrosalicylic acid, an oxalic acid, phosphomolybdic acid, phosphoric acid, phosphorosilicic acid, phthalic acids, salicylic acid, tantalic acid, vanadium acids, a tartaric acid, a tungstic acid, a salt thereof, an ester thereof and a mixture thereof.

40. The process according to claim 31, wherein the at least one mobile anti-corrosive anion is selected from the group consisting of TiF₆²⁻, ZrF₆²⁻, CeO₄⁴⁻, MnO₄⁻, MnO₄²⁻, MoO₄²⁻, MoO₄⁴⁻, VO₄²⁻, WO₄²⁻ and WO₄⁴⁻ and undergoes a ligand exchange, valency or solubility change, and forms an oxidic protective layer in a region of the defect or in a region of a delamination front.

41. The process according to claim 31, wherein at least one anion is selected from the group consisting of an anion based on a carboxylate, a complex fluoride, a molybdate, a nitro compound, a phosphorus-containing oxyanion, a polysiloxane, a silane, a siloxane or a surfactant.

42. The process according to claim 31, wherein an anion is added to or is incorporated in the conductive polymer, which anions additionally have a delamination-inhibiting effect or coupling effect on the metallic surface.

43. The process according to claim 31, wherein the conductive polymer-containing particles are ground, dried, annealed or redispersed before the addition of a liquid or before they are added to the composition.

44. The process according to claim 31, wherein the composition substantially optionally contain, apart from the conductive polymer-containing particles and apart from water or at least one other solvent, also a binder system based on organic polymer or silicon dioxide/silicate.

45. The process according to claim 31, wherein conductive polymer-containing particles are used, in which at least two types of particles are employed that have significantly different particle size distributions, or in which at least two differently produced types of particles are employed.

46. The process according to claim 31, wherein as binder system at least one organic polymer is chosen that is or becomes anionically or cationically stabilized and that can optionally also undergo film-forming.

47. The process according to claim 31, wherein as binder system a system is selected in which at least one organic polymer which is contained in the composition undergoes film-forming when the composition is dried.

48. The process according to claim 31, wherein as binder system a system is selected which is chemically or free-radically crosslinked via at least one thermal crosslinking agent or via at least one photoinitiator.

49. The process according to claim 31, wherein to the composition containing a binder system is added at least one additive selected from the group consisting of biocides, chelates, antifoaming agents, film-forming auxiliary substances emulsifiers, lubricants, coupling agents, complex-forming agents, inorganic or organic corrosion inhibitors, wetting agents, pigments, acid traps, protective colloids, stabilizers, surfactants, crosslinking agents, plasticizers, aluminum compounds, cerium compounds, lanthanum compounds, manganese compounds, rare earth compounds, molybdenum compounds, titanium compounds, tungsten compounds, yttrium compounds, zinc compounds and zirconium compounds.

50. The process according to claim 31, wherein the composition is applied by roller application, flow coating, knife coating, sprinkling, spray coating, brushing or dipping, and if necessary followed by squeezing off with a roller.

51. The process according to claim 31, wherein the aqueous composition is applied at a temperature in the range from 5° to 50° C. to the metallic surface, that the metallic surface is maintained at temperatures in the range from 5° to 120° C. during the application of the coating, or that the coated metallic surface is dried at a temperature in the range from 20° to 400° C. peak metal temperature (PMT).

52. The process according to claim 31, wherein the metallic surface to be coated is cleaned, pickled, rinsed before the treatment with said composition, or is provided with a passivation layer, treatment layer, pretreatment layer, with an oil layer or with a thin or very thin coating that largely contains conductive polymer and is only limitedly or completely sealed, and if necessary is subsequently at least partially freed from this layer before applying said composition.

53. The process according to claim 31, wherein strips are coated with the composition according to claim 31 and are wound into a coil, optionally after cooling to a temperature in the range from 20° to 70° C.

54. The process according to claim 31, wherein the coated metallic surface is provided with at least one further coating based on a post-rinse solution, on organic polymer, paint, adhesive, adhesive carrier or oil.

55. The process according to claim 31, wherein the coated metal parts, strips, strip sections, wires or profiled sections are formed, painted, coated with polymer such as for example. PVC, printed, bonded, hot-soldered, welded or joined to one another or to other elements by clinching or other joining techniques.

56. A composition for coating a metallic surface, wherein the composition contains:
at least one water-soluble or water-dispersible organic polymer,
particles containing at least one type of conductive polymer,
water,
optionally at least one organic solvent, and
optionally at least one additive,
wherein the conductive polymer is at least one based on polyphenylene, polyfuran, polyimidazole, polyphenanthrene, polypyrrole, polythiophene or polythiophenylene, which is charged with anti-corrosive mobile anions.

57. A composition according to claim 56, comprising a conductive polymer that comprises titanium or zirconium anions.

58. An article comprising the metallic surface with a coating based on binder system, particles and conductive polymer, in which the coating is produced according to claim 31.

59. An article comprising the metallic surface prepared according to claim 31, wherein the coating contains conductive polymer that comprises an anion containing titanium or zirconium or the coating contains at least one compound of titanium or zirconium.

52. The process according to claim 31, wherein the at least one anion is based on a carboxylic acid, a hydroxycarboxylic acid, an oxycarboxylic acid, a dicarboxylic acid, a tricarboxylic acid, a di-substituted or tri-substituted arenecarboxylic acid, a meta- ortho- or para-substituted arenecarboxylic acid, an arene acid containing an amino or an OH group, a mineral oxyacid, a boron-containing acid, a manganese-containing acid, a fluorosilicic acid, an acid with a content of at least one element from the a rare earth or yttrium, a titanium-containing acid, a vanadium-containing acid, a tungsten-containing acid, a tin-containing acid, a zirconium-containing acid, benzoic acid, succinic acid, tetrafluorosilicic acid, hexafluorotitanic acid, hexafluorozirconic acid, gallic acid, hydroxyacetic acid, a lactic acid, a niobic acid, a nitrosalicylic acid, phosphomolybdic acid, pbosphorosilicic acid, phthalic acids, salicylic acid, tantalic acid, vanadium acids, a tartaric acid, a tungstic acid, TiF₆²⁻, ZrF₆²⁻, CeO₄⁴⁻, MnO₄⁻, MnO₄²⁻, MoO₄⁴⁻, VO₄²⁻, WO₄²⁻ and WO₄⁴⁻, a carboxylate, a complex fluoride, a polysiloxane, a silane, a siloxane, a surfactant, a salt thereof, an ester thereof or a mixture thereof;
